(19) United States
(12) Patent Application Publication
(10) Pub. No.: US 2022/0201582 A1
(43) Pub. Date: Jun. 23, 2022

(54) Improvement of Conditional Handover Parameters in 5G

(71) Applicant: Telefonaktiebolaget LM Ericsson (publ), Stockholm (SE)

(72) Inventors: Cecilia Eklöf, Täby (SE); Icaro L. J. Da Silva, Solna (SE); Mattias Bergström, Sollentuna (SE)

(21) Appl. No.: 17/599,165

(22) PCT Filed: Mar. 26, 2020
(86) PCT No.: PCT/SE2020/050311

§ 371 Date: Sep. 28, 2021

Related U.S. Application Data
(60) Provisional application No. 62/825,409, filed on Mar. 28, 2019.

(51) Int. Cl. H04W 36/30; H04W 36/00; H04W 24/08

(52) U.S. Cl. CPC H04W 36/305; H04W 24/08; H04W 36/00837

(57) ABSTRACT

A wireless device (16) is configured to detect a failure by the wireless device (16) to perform a conditional mobility procedure, e.g., a conditional handover procedure. The wireless device (16) is configured to transmit, to a network node (18), a message (28) that indicates, and/or includes information about, the failure by the wireless device (16) to perform the conditional mobility procedure. The network node (18) in some embodiments tunes one or more parameters at the network node (18) based on the information about the failure by the wireless device (16) to perform the conditional mobility procedure.

### TECHNICAL FIELD

The present application relates generally to a wireless communication network, and more particularly relates to conditional mobility in such a network.

### BACKGROUND

Robustness of mobility procedures to failure proves challenging particularly in New Radio (NR) systems whose radio links are more prone to fast fading due to their higher operating frequencies. Conditional mobility is one approach to improve mobility robustness in this regard. Under this approach, a wireless device may be commanded to perform a mobility procedure, e.g., handover or resume, earlier than traditionally commanded, before the source radio link quality deteriorates below a certain threshold. But the wireless device is commanded to wait to perform that mobility procedure until the wireless device detects that a certain condition is fulfilled, e.g., the source radio link quality deteriorates even further below a different threshold. Once the device detects that condition, the device may autonomously perform the mobility procedure without receiving any other signaling on the source radio link, so that the procedure proves robust to source link deterioration.

Although this conditional mobility approach can improve mobility robustness, distributing more control over the mobility procedure to the wireless device threatens the network's ability to adapt future mobility procedures based on the performance of past mobility procedures. This may in turn jeopardize the ability of the conditional mobility approach to avoid mobility failure and/or poor service performance.

### SUMMARY

According to some embodiments herein, a wireless device indicates and/or informs a wireless communication network about a failure by the wireless device to perform a conditional mobility procedure, e.g., a conditional handover procedure. The wireless device may for instance indicate the occurrence of, the timing of, and/or the cause of the failure. The network in some embodiments may tune one or more parameters based on this information from the wireless device. The parameter(s) may for example impact future mobility procedures, e.g., with the aim to reduce the chances of the conditional mobility procedure failing again in the future, mitigate the effects of such failure, or the like.

More particularly, embodiments herein include a method performed by a wireless device. The method may include detecting a failure by the wireless device to perform a conditional mobility procedure. The method may further comprise transmitting to a network node a message that indicates, and/or includes information about, the failure by the wireless device to perform the conditional mobility procedure.

In some embodiments, the message reports a connection failure experienced by the wireless device, where the message includes a failure type field that indicates the connection failure was due to the failure by the wireless device to perform the conditional mobility procedure.

In some embodiments, the message includes information about a cause of the failure by the wireless device to perform the conditional mobility procedure.

In some embodiments, the failure is caused by an inability of the wireless device to comply with a configuration for a target cell of the conditional mobility procedure. In one such embodiment, the message indicates which configuration the wireless device was unable to comply with and/or which target cell was associated with the configuration.

In some embodiments, the failure is caused by failure of the wireless device to connect to a target cell of the conditional mobility procedure after fulfillment of one or more conditions for performing the conditional mobility procedure. In other embodiments, the failure is caused by expiration of a first timer before the conditional mobility procedure has successfully completed, where the first timer is started when the wireless device detects fulfillment of one or more conditions for performing the conditional mobility procedure. In still other embodiments, the failure is caused by radio link failure while the wireless device was monitoring for fulfillment of one of more conditions for performing the conditional mobility procedure. In yet other embodiments, the failure is caused by expiration of a second timer, where the second timer is configured to start when a downlink quality falls below a threshold. In some embodiments, the failure is caused by a random access problem or a maximum number of retransmissions being reached.

In some embodiments, the method further comprises receiving a conditional mobility configuration for the conditional mobility procedure and checking whether the wireless device is able to comply with the conditional mobility configuration, where the message is transmitted based on the wireless device being unable to comply with the conditional mobility configuration according to said checking.

In other embodiments, the conditional mobility configuration includes a monitoring configuration, where the monitoring configuration is a configuration that the wireless device is to apply in order to monitor for fulfillment of a condition under which the wireless device is to perform the conditional mobility procedure. In one such embodiment, said checking comprises checking whether the wireless device is able to comply with the monitoring configuration. In this case, the message may be transmitted based on the wireless device being unable to comply with the monitoring configuration according to said checking.

In some embodiments, the method further comprises, responsive to said detecting, storing the information about the failure at the wireless device, where the information included in the message transmitted to the network node includes the stored information.

In some embodiments, the method further comprises, responsive to said detecting, performing cell selection to select a suitable cell and, if the suitable cell selected is a cell for which the wireless device has a stored conditional mobility configuration, applying the stored conditional mobility configuration. The method may further comprise transmitting a message to the suitable cell selected indicating that a failure report is available at the wireless device

Embodiments herein also include a method performed by a network node. The method may comprise receiving, from a wireless device, a message that indicates, and/or includes information about, a failure by the wireless device to perform a conditional mobility procedure.

In some embodiments, the message reports a connection failure experienced by the wireless device, where the message includes a failure type field that indicates the connection failure was due to the failure by the wireless device to perform the conditional mobility procedure.

In some embodiments, the message includes information about a cause of the failure by the wireless device to perform the conditional mobility procedure.

In some embodiments, the failure is caused by an inability of the wireless device to comply with a configuration for a target cell of the conditional mobility procedure. In one such embodiment, the message indicates which configuration the wireless device was unable to comply with and/or which target cell was associated with the configuration.

In some embodiments, the failure is caused by failure of the wireless device to connect to a target cell of the conditional mobility procedure after fulfillment of one or more conditions for performing the conditional mobility procedure. In other embodiments, the failure is caused by expiration of a first timer before the conditional mobility procedure has successfully completed, where the first timer is started when the wireless device detects fulfillment of one or more conditions for performing the conditional mobility procedure. In still other embodiments, the failure is caused by radio link failure while the wireless device was monitoring for fulfillment of one of more conditions for performing the conditional mobility procedure. In yet other embodiments, the failure is caused by expiration of a second timer, where the second timer is configured to start when a downlink quality falls below a threshold. In some embodiments, the failure is caused by a random access problem or a maximum number of retransmissions being reached.

In some embodiments, the method further comprises transmitting, to the wireless device, a conditional mobility configuration for the conditional mobility procedure, where the message is received based on the wireless device being unable to comply with the conditional mobility configuration. In one such embodiment, the conditional mobility configuration includes a configuration for a target cell of the conditional mobility procedure, and the message is received based on the wireless device being unable to comply with the configuration for the target cell

In other embodiments, the conditional mobility configuration includes a monitoring configuration, where the monitoring configuration is a configuration that the wireless device is to apply in order to monitor for fulfillment of a condition under which the wireless device is to perform the conditional mobility procedure. In one such embodiment, the message may be received based on the wireless device being unable to comply with the monitoring configuration.

In some embodiments, the method further comprises tuning one or more parameters at the network node based on the information about the failure by the wireless device to perform the conditional mobility procedure.

Embodiments herein further include corresponding apparatus, computer programs, and carriers of those computer programs, e.g., in the form of non-transitory computer-readable mediums. For example, embodiments herein include a wireless device. The wireless device may be configured, e.g., via communication circuitry and processing circuitry, to detect a failure by the wireless device to perform a conditional mobility procedure, and to transmit to a network node a message that indicates, and/or includes information about, the failure by the wireless device to perform the conditional mobility procedure.

Embodiments herein further include a network node. The network node may be configured, e.g., via communication circuitry and processing circuitry, to receive, from a wireless device, a message that indicates, and/or includes information about, a failure by the wireless device to perform a conditional mobility procedure.

### BRIEF DESCRIPTION OF THE DRAWINGS

FIG. 1 is a block diagram of a wireless communication network according to one or more embodiments.

FIG. 2A is a logic flow diagram of a method performed by a wireless device according to some embodiments.

FIG. 2B is a logic flow diagram of a method performed by a network node according to some embodiments.

FIG. 3A is a logic flow diagram of a method performed by a radio network node according to some embodiments.

FIG. 3B is a logic flow diagram of a method performed by a radio network node according to other embodiments.

FIG. 4 is a logic flow diagram of a method performed by a wireless device according to other embodiments.

FIG. 5 is a block diagram of a wireless device according to some embodiments.

FIG. 6 is a block diagram of a network node according to some embodiments.

FIG. 7A and FIG. 7B are call flow diagrams of a handover procedure according to some embodiments.

FIG. 8 is a call flow diagram of a conditional handover procedure according to some embodiments.

FIG. 9 is a call flow diagram of a conditional handover procedure according to other embodiments.

FIG. 10 is a block diagram of a wireless communication network according to some embodiments.

FIG. 11 is a block diagram of a user equipment according to some embodiments.

FIG. 12 is a block diagram of a virtualization environment according to some embodiments.

FIG. 13 is a block diagram of a communication network with a host computer according to some embodiments.

FIG. 14 is a block diagram of a host computer according to some embodiments.

FIG. 15 is a flowchart illustrating a method implemented in a communication system, in accordance with one embodiment.

FIG. 16 is a flowchart illustrating a method implemented in a communication system, in accordance with one embodiment.

FIG. 17 is a flowchart illustrating a method implemented in a communication system, in accordance with one embodiment.

FIG. 18 is a flowchart illustrating a method implemented in a communication system, in accordance with one embodiment.

### DETAILED DESCRIPTION

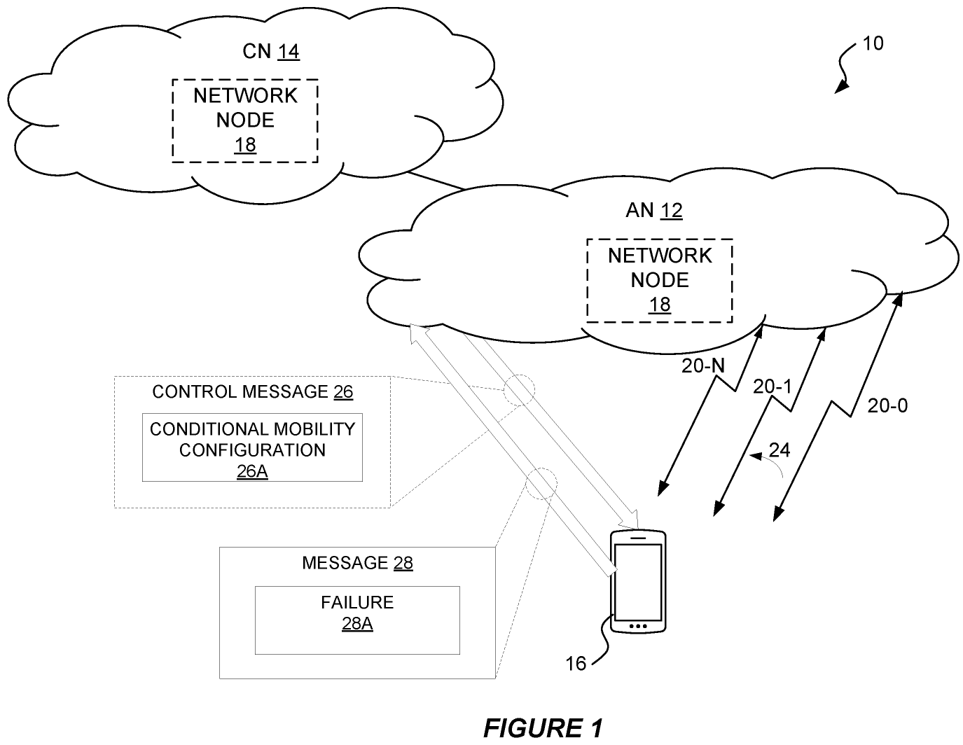

FIG. 1 illustrates a wireless communication network 10 according to one or more embodiments. As shown, the network 10, e.g., a 5G network or New Radio, NR, network, may include an access network (AN) 12 and a core network (CN) 14. The AN 12 wirelessly connects a wireless communication device 16 (or simply “wireless device 16”) to the CN 14. The CN 14 in turn connects the wireless device 16 to one or more external networks (not shown), such as a public switched telephone network and/or a packet data network, e.g., the Internet.

The AN 12 provides links via which the wireless device 16 may wirelessly access the system 10, e.g., using uplink and/or downlink communications. The AN 12 may for example provide links 20-0, 20-1, . . . 20-N (generally links 20) in the form of access nodes, e.g., base stations, cells, sectors, beams, carriers, or the like. Some links 20 may provide wireless coverage over different geographical areas.

The network 10, e.g., via one or more network nodes 18 in the AN 12 and/or CN 14, may control configuration of the wireless device 16 in a number of respects. That is, the network 10 may control application by the wireless device 16 of different possible types of configurations. For example, the network 10 may control the device's configuration in terms of which link 20 the device 16 uses to access the network 10, e.g., in or for a so-called connected mode, which may for instance be a mode in which the device 16 has established a radio resource control, RRC, connection with the network 10, in contrast with an RRC idle mode in which no RRC connection is established. The network 10 in this regard may transmit to the wireless device 16 a type of configuration, e.g., a mobility configuration, that, when applied by the wireless device 16, configures the device 16 to use certain link(s) 20 to access the network 10. In some embodiments, a mobility configuration may for example configure the device 16 to perform a mobility procedure that causes the device 16 to switch 24 from accessing the network 10 via one link to accessing the system via another link, e.g., in connected mode. In some embodiments, this link switch 24 may be a handover. In another respect, the network 10 may control the device's configuration in terms of how many links the device 16 uses to access the network 10, e.g., in the context of dual connectivity, carrier aggregation, or the like. For example, the network 10 may signal a different type of configuration to the device 16 for adding a secondary cell group (SCG) or a secondary cell. In still other embodiments, the network 10 may signal another type of configuration to the device 16 for resuming a connection, e.g., an RRC connection resume, for a reconfiguration with sync, for a reconfiguration, for a reestablishment, or the like. In yet other respects, the network 10 may signal a different type of configuration that configures the wireless device 16 to perform a measurement, or still another type of configuration that configures the wireless device 16 to record/log certain information.

According to embodiments herein, the network 10 may transmit a mobility configuration to the wireless device 16 but indicate that the wireless device 16 is to only conditionally apply that configuration. In this sense, then, the network 10 as shown in FIG. 1 transmits to the wireless device 16 a so-called conditional mobility configuration 26A that is a configuration that the wireless device 16 is to conditionally apply. In this case, the wireless device 16 is commanded to wait to apply the configuration 26A until the wireless device 16 detects that a condition is fulfilled, e.g., the source radio link quality deteriorates even further below a different threshold. Once the wireless device 16 detects the condition, the wireless device 16 may autonomously apply the configuration 26A without receiving any other signaling.

More particularly, the network node 18 in the embodiments shown in FIG. 1 may transmit to the wireless device 16 a control message 26, e.g., in the form of a Radio Resource Control (RRC) message such as an RRC reconfiguration message or an RRC conditional reconfiguration message. The control message 26 may include or otherwise indicate the conditional mobility configuration 26A, either by itself or along with one or more other conditional configurations (not shown). The conditional mobility configuration 26A includes a mobility configuration that the wireless device 16 is to apply when the wireless device 16 detects fulfillment of the condition, which may also be indicated by the control message 26. When the wireless device 16 applies the mobility configuration, the wireless device 16 performs a mobility procedure, e.g., a handover procedure or resume procedure. With the mobility procedure's performance being conditional on the condition, the mobility procedure may be referred to as a conditional mobility procedure.

In some embodiments, though, the wireless device 16 may fail to perform the conditional mobility procedure. As used herein, a failure by the wireless device 16 to perform the conditional mobility procedure means that the wireless device 16 does not succeed in performing the conditional mobility procedure as expected according to the conditional mobility configuration 26A received by the wireless device 16. The wireless device 16 may fail to perform the conditional mobility procedure for any number of reasons. One reason, for example, may be that the wireless device 16 is unable to comply with at least a part of the conditional mobility configuration 26A. The wireless device 16 may for instance detect that it is unable to comply with at least part of the conditional mobility configuration 26A upon receiving the conditional mobility configuration 26A, e.g., without regard to fulfillment of condition(s) for performing the conditional mobility procedure. Another reason may be that, while monitoring for the fulfillment of condition(s) for performing the conditional mobility procedure according to the conditional mobility configuration 26A, the wireless device 16 experiences radio link failure (RLF). Yet another reason may be that, after fulfillment of the condition(s) for performing the conditional mobility procedure, the conditional mobility procedure does not complete successfully within a required time limit, e.g., as governed by a timer Txxx. Note, though, that non-fulfillment of condition(s) for performing the conditional mobility procedure does not amount to a failure by the wireless device 16 to perform the conditional mobility procedure because such behavior is expected according to the conditional mobility configuration 26A.

Notably, according to some embodiments, the wireless device 16 is configured to transmit to a network node 18 (e.g., in the AN 12 or the CN 14) a message 28 that indicates, and/or that includes information about, such a failure. That is, the message 28 indicates, and/or includes information about, a failure 28A by the wireless device 16 to perform a conditional mobility procedure. In some embodiments, for example, the message 28 indicates the occurrence of, the timing of, and/or the cause of the failure 28A by the wireless device 16 to perform the conditional mobility procedure. In this regard, the failure 28A as described above may have any of multiple possible causes, including for instance expiration of a certain timer (e.g., Txxx, T310, etc.), a random access problem, a maximum number of retransmissions reached, and/or inability of the wireless device 16 to comply with a configuration for a target (e.g., target cell) of the conditional mobility procedure. In this latter case, the wireless device 16 may for instance not support a certain random access configuration or security parameters used by the target. Alternatively or additionally, the message 28 may indicate a measurement performed by the wireless device 16 on a target cell of the conditional mobility procedure or on a cell using the same frequency as the target cell.

In some embodiments, the network node 18 exploits the message 28 in order to tune one or more parameters at the network node 18 (or in the network 10 generally). The tuning may for instance aim to reduce the chances of the conditional mobility procedure failing again in the future, mitigate the effects of such failure, or the like.

In some embodiments, the message 28 is dedicated to reporting the occurrence of the failure 28A. In other embodiments, the message 28 actually reports the occurrence of a connection failure experienced by the wireless device 16 and indicates the failure 28A as being the cause of the connection failure. That is, the message 28 in this case indicates the failure 28A to perform the conditional mobility procedure, but only incidentally as the cause of a connection failure. In still other embodiments, the message 28 is a request to reestablish an RRC connection and indicates the failure 28A as being the cause that triggered the RRC connection re-establishment.

Note that in some embodiments the message 28 is a response to a request from the network node 18 for information. The message 28 may for instance be a UIInformationResponse message, e.g., as described below for RRC.

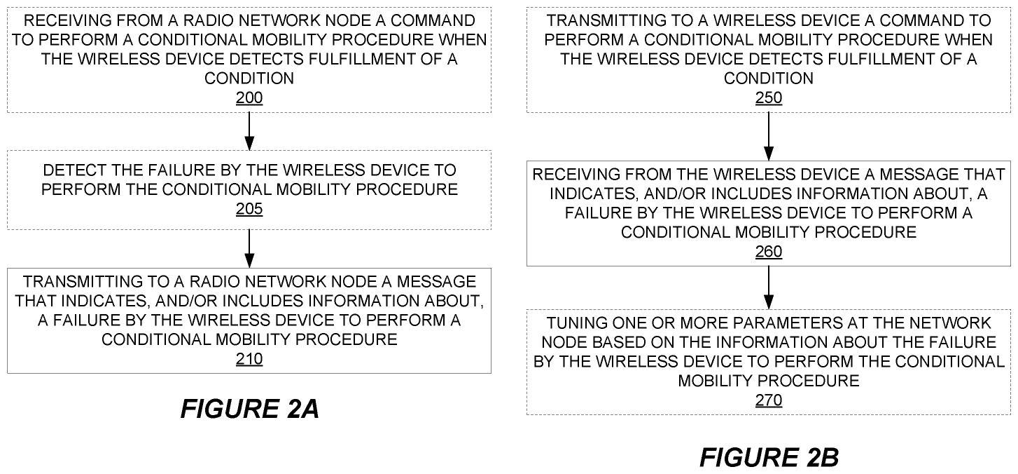

In view of the modifications and variations herein, FIG. 2A depicts a method performed by a wireless device 16 in accordance with particular embodiments, e.g., for reporting failure information in a wireless communication network 10 and/or for facilitating conditional mobility in a wireless communication network 10. The method as shown includes transmitting to a network node 18 a message 28 that indicates, and/or includes information about, a failure 28A by the wireless device 16 to perform a conditional mobility procedure (Block 210). The conditional mobility procedure may for example be a conditional handover procedure or a conditional resume procedure.

In some embodiments, the method may also include detecting the failure 28A by the wireless device 16 to perform the conditional mobility procedure (Block 205).

Alternatively or additionally, the method may comprise receiving, from a radio network node, a command to perform the conditional mobility procedure when the wireless device 16 detects fulfilment of a condition (Block 200).

In some embodiments, the method further comprises, responsive to detecting failure by the wireless device 16 to perform the conditional mobility procedure, storing the information about the failure at the wireless device 16. In this case, the information included in the message 28 transmitted to the network node 18 may include the stored information.

FIG. 2B depicts a method performed by a network node 18 in accordance with other particular embodiments, e.g., for facilitating conditional mobility in a wireless communication network 10. The method comprises receiving, from a wireless device 16, a message 28 that indicates, and/or includes information about, a failure 28A by the wireless device 16 to perform a conditional mobility procedure (Block 260). The conditional mobility procedure may for example be a conditional handover procedure or a conditional resume procedure.

In some embodiments, the method also comprises transmitting to the wireless device 16 a command to perform the conditional mobility procedure when the wireless device 16 detects fulfillment of a condition (Block 250).

Alternatively or additionally, the method may further comprise transmitting, to the wireless device 16, an information request message that requests the information from the wireless device 16. In one such embodiment, the received message is an information response message received in response to the information request message.

In some embodiments, the network node 18 is a source radio network node of the conditional mobility procedure.

In some embodiments, the method further comprises tuning one or more parameters at the network node 18 based on the information about the failure 28A by the wireless device 16 to perform the conditional mobility procedure (Block 270).

Regardless, in any of the embodiments in FIG. 2A or FIG. 2B, the received message 28 may report a connection failure experienced by the wireless device 16. In one such embodiment, the message 28 includes a failure type field that indicates the connection failure was due to the failure 28A by the wireless device 16 to perform the conditional mobility procedure. In one such embodiment, the conditional mobility procedure is a conditional handover procedure, and the failure type field indicates the connection failure was due to conditional handover failure.

Alternatively or additionally, the message 28 in some embodiments includes information about a cause of the failure 28A by the wireless device 16 to perform the conditional mobility procedure. For example, in one or more embodiments, the conditional mobility procedure is a mobility procedure that the wireless device 16 is to perform when the wireless device 16 detects fulfillment of one or more conditions. In this case, the information about the cause of the failure 28A may indicate the cause of the failure as being expiration of a first timer, where the first timer is started when the one or more conditions are fulfilled, and where the conditional mobility procedure is considered failed if the first timer expires before the conditional mobility procedure has successfully completed. In other embodiments where the conditional mobility procedure is a mobility procedure that the wireless device 16 is to perform when the wireless device 16 detects fulfillment of one or more conditions, the information about the cause of the failure 28A may indicate the cause of the failure 28A as being radio link failure while the wireless device 16 was monitoring for fulfillment of the one or more conditions.

In still other embodiments from FIG. 2A or FIG. 2B, the information about the cause of the failure may indicate the cause of the failure 28A as being expiration of a second timer that was started when a downlink quality fell below a threshold, as being a random access problem, or as a maximum number of retransmissions being reached. In other embodiments, the information about the cause of the failure may indicate the cause of the failure 28A as being inability of the wireless device 16 to comply with a configuration for a target cell of the conditional mobility procedure.

In any event, the information included in the message 28 may indicate the occurrence of, the timing of, and/or the cause of the failure 28A by the wireless device 16 to perform the conditional mobility procedure.

Alternatively or additionally, the information included in the message 28 may indicate a measurement performed by the wireless device 16 on a target cell of the conditional mobility procedure or on a cell using the same frequency as the target cell.

In these and other embodiments from FIG. 2A or FIG. 2B, the message 28 may be a request to reestablish a radio resource control (RRC) connection, and the message 28 may indicate a cause that triggered RRC connection re-establishment as being the failure by the wireless device 16 to perform a conditional mobility procedure. Or, in other embodiments, the message 28 is a request to reestablish a radio resource control (RRC) connection, and indicates a cause that triggered RRC connection re-establishment as being inability of the wireless device 16 to comply with a configuration for a target cell of the conditional mobility procedure. In one such embodiment, the message 28 may indicate which configuration the wireless device 16 was unable to comply with and/or which target cell was associated with the configuration.

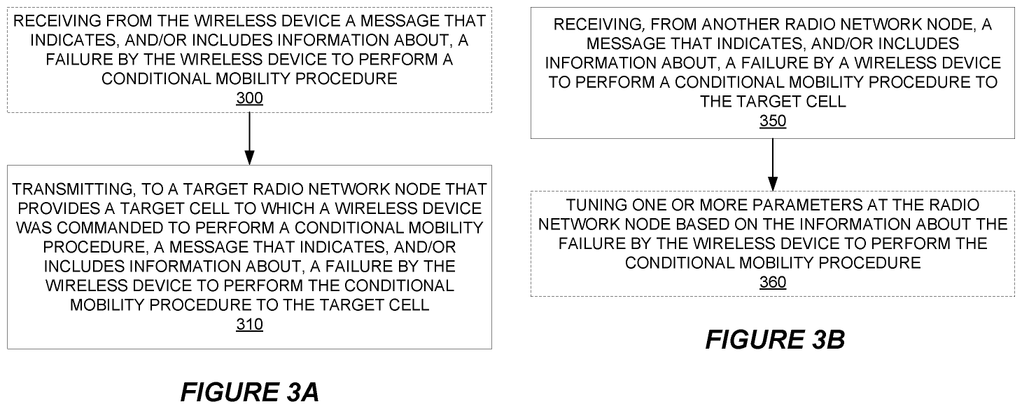

FIG. 3A depicts a method performed by a radio network node in accordance with particular embodiments, e.g., for reporting failure information in a wireless communication network 10 and/or for facilitating conditional mobility in a wireless communication network 10. The method comprises transmitting, to a target radio network node that provides a target cell to which a wireless device 16 was commanded to perform a conditional mobility procedure, a message that indicates, and/or includes information about, a failure by the wireless device 16 to perform the conditional mobility procedure to the target cell (Block 310). The conditional mobility procedure may for example be a conditional handover procedure or a conditional resume procedure.

In some embodiments, the network node is a source radio network node of the conditional mobility procedure. In other embodiments, the network node is a radio network node to which the wireless device re-established an RRC connection after the failure to perform the conditional mobility procedure.

In some embodiments, the message is a handover report message.

In some embodiments, the information included in the message indicates the occurrence of, the timing of, and/or the cause of the failure by the wireless device 16 to perform the conditional mobility procedure to the target cell. Alternatively or additionally, the information included in the message indicates a cause of the failure to perform the conditional mobility procedure as being inability of the wireless device 16 to comply with a configuration for the target cell.

In some embodiments, the method also comprises receiving, from the wireless device 16, a message 28 that indicates, and/or includes information about, a failure 28A by the wireless device 16 to perform the conditional mobility procedure (Block 300).

FIG. 3B depicts a method performed by a radio network node configured to provide a target cell in accordance with other particular embodiments, e.g., for facilitating conditional mobility in a wireless communication network 10. The method may comprise receiving, from another radio network node, a message that indicates, and/or includes information about, a failure by a wireless device 16 to perform a conditional mobility procedure to the target cell (Block 350). The conditional mobility procedure may for example be a conditional handover procedure or a conditional resume procedure.

In some embodiments, the other radio network node is a source radio network node of the conditional mobility procedure. In other embodiments, the other radio network node is a radio network node to which the wireless device re-established an RRC connection after the failure to perform the conditional mobility procedure.

In some embodiments, the message is a handover report message.

In some embodiments, the information included in the message indicates the occurrence of, the timing of, and/or the cause of the failure by the wireless device 16 to perform the conditional mobility procedure to the target cell. Alternatively or additionally, the information included in the message indicates a cause of the failure to perform the conditional mobility procedure as being inability of the wireless device 16 to comply with a configuration for the target cell.

In some embodiments, the method also comprises tuning one or more parameters at the radio network node based on the information about the failure by the wireless device 16 to perform the conditional mobility procedure (Block 360).

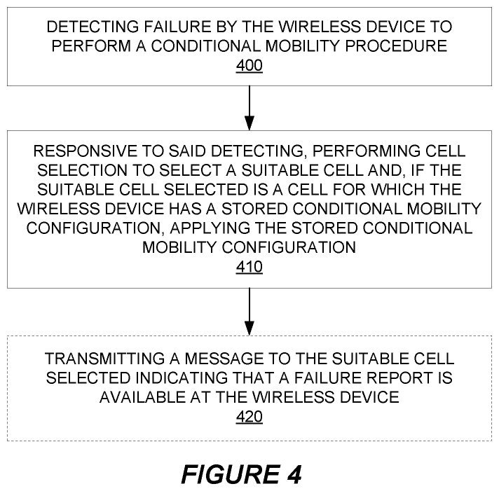

FIG. 4 depicts a method performed by a wireless device 16 in accordance with particular embodiments, e.g., for handling conditional mobility failure. The method comprises detecting failure by the wireless device 16 to perform a conditional mobility procedure (Block 400). The method also comprises, responsive to said detecting, performing cell selection to select a suitable cell and, if the suitable cell selected is a cell for which the wireless device 16 has a stored conditional mobility configuration, applying the stored conditional mobility configuration (Block 410). In some embodiments, the method also comprises transmitting a message to the suitable cell selected indicating that a failure report is available at the wireless device (Block 420).

Embodiments herein also include corresponding apparatuses. Embodiments herein for instance include a wireless device 16 configured to perform any of the steps of any of the embodiments described above for the wireless device 16.

Embodiments also include a wireless device 16 comprising processing circuitry and power supply circuitry. The processing circuitry is configured to perform any of the steps of any of the embodiments described above for the wireless device 16. The power supply circuitry is configured to supply power to the wireless device 16.

Embodiments further include a wireless device 16 comprising processing circuitry. The processing circuitry is configured to perform any of the steps of any of the embodiments described above for the wireless device 16. In some embodiments, the wireless device 16 further comprises communication circuitry.

Embodiments further include a wireless device 16 comprising processing circuitry and memory. The memory contains instructions executable by the processing circuitry whereby the wireless device 16 is configured to perform any of the steps of any of the embodiments described above for the wireless device 16.

Embodiments moreover include a user equipment (UE). The UE comprises an antenna configured to send and receive wireless signals. The UE also comprises radio front-end circuitry connected to the antenna and to processing circuitry, and configured to condition signals communicated between the antenna and the processing circuitry. The processing circuitry is configured to perform any of the steps of any of the embodiments described above for the wireless device 16. In some embodiments, the UE also comprises an input interface connected to the processing circuitry and configured to allow input of information into the UE to be processed by the processing circuitry. The UE may comprise an output interface connected to the processing circuitry and configured to output information from the UE that has been processed by the processing circuitry. The UE may also comprise a battery connected to the processing circuitry and configured to supply power to the UE.

Embodiments herein also include a network node 18 configured to perform any of the steps of any of the embodiments described above for the network node 18.

Embodiments also include a network node 18 comprising processing circuitry and power supply circuitry. The processing circuitry is configured to perform any of the steps of any of the embodiments described above for the network node 18. The power supply circuitry is configured to supply power to the network node 18.

Embodiments further include a network node 18 comprising processing circuitry. The processing circuitry is configured to perform any of the steps of any of the embodiments described above for the network node 18. In some embodiments, the network node 18 further comprises communication circuitry.

Embodiments further include a network node 18 comprising processing circuitry and memory. The memory contains instructions executable by the processing circuitry whereby the network node 18 is configured to perform any of the steps of any of the embodiments described above for the network node 18.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

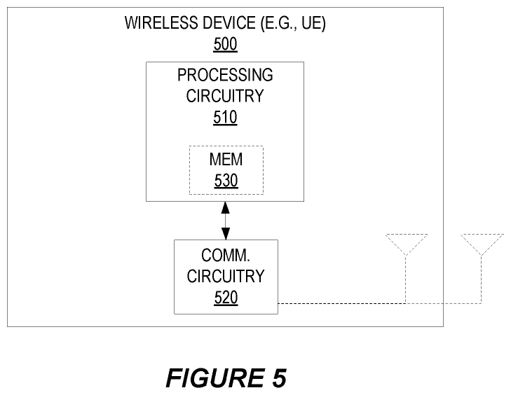

FIG. 5 for example illustrates a wireless device 500, e.g., a user equipment (UE), as implemented in accordance with one or more embodiments. The wireless device 500 in some embodiments is the wireless device 16 shown in FIG. 1. As shown, the wireless device 500 includes processing circuitry 510 and communication circuitry 520. The communication circuitry 520 (e.g., radio circuitry) is configured to transmit and/or receive information to and/or from one or more other nodes, e.g., via any communication technology. Such communication may occur via one or more antennas that are either internal or external to the wireless device 500. The processing circuitry 510 is configured to perform processing described above, e.g., in FIG. 2A and/or FIG. 4, such as by executing instructions stored in memory 530. The processing circuitry 510 in this regard may implement certain functional means, units, or modules.

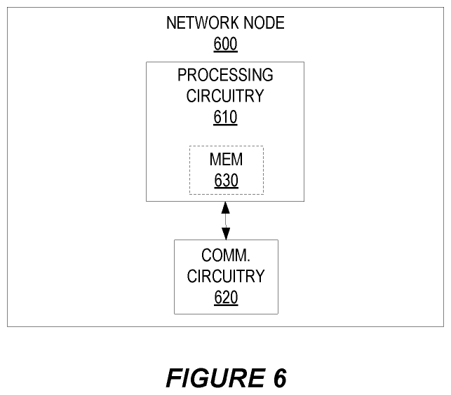

FIG. 6 illustrates a network node 600, e.g., network node 18, as implemented in accordance with one or more embodiments. As shown, the network node 600 includes processing circuitry 610 and communication circuitry 620. The communication circuitry 620 is configured to transmit and/or receive information to and/or from one or more other nodes, e.g., via any communication technology. The processing circuitry 610 is configured to perform processing described above, e.g., in FIG. 2B, FIG. 3A, or FIG. 3B, such as by executing instructions stored in memory 630. The processing circuitry 610 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts and/or wireless network types for illustrative purposes, but the embodiments are similarly applicable in other contexts and/or wireless network types not explicitly described. In the below, a user equipment (UE) is shown as an example of a wireless device 16, and a conditional handover is an example of a conditional mobility procedure. Various types of messages are discussed as examples of the message 28 herein.

An RRC_CONNECTED user equipment (UE) in Long Term Evolution (LTE) (also called EUTRA) can be configured by the network to perform measurements and, upon triggering measurement reports the network may send a handover command to the UE (in LTE an RRConnectionReconfiguration with a field called mobilityControlInfo and in New Radio (NR) an RRCReconfiguration with a reconfigurationWithSync field).

These reconfigurations are actually prepared by the target cell upon a request from the source node (over X2 interface in case of EUTRA-EPC or Xn interface in case of EUTRA-5GC or NR) and takes into account the existing RRC configuration the UE has with source cell (which are provided in the inter-node request). Among other parameters, that reconfiguration provided by the target cell contains all of the information the UE needs to access the target cell, e.g., random access configuration, a new Cell Radio Network Temporary Identity (C-RNTI) assigned by the target cell and security parameters enabling the UE to calculate new security keys associated to the target cell so the UE can send a handover complete message on Signaling Radio Bearer #1 (SRB1) (encrypted and integrity protected) based on new security keys upon accessing the target cell.

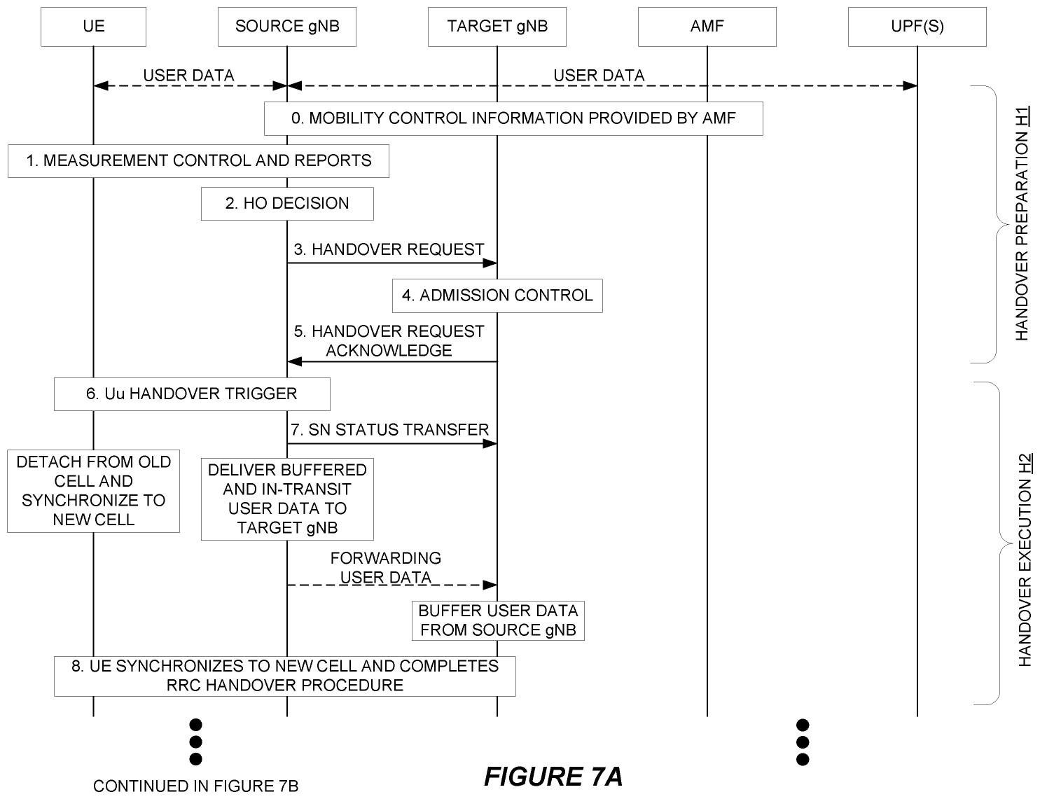

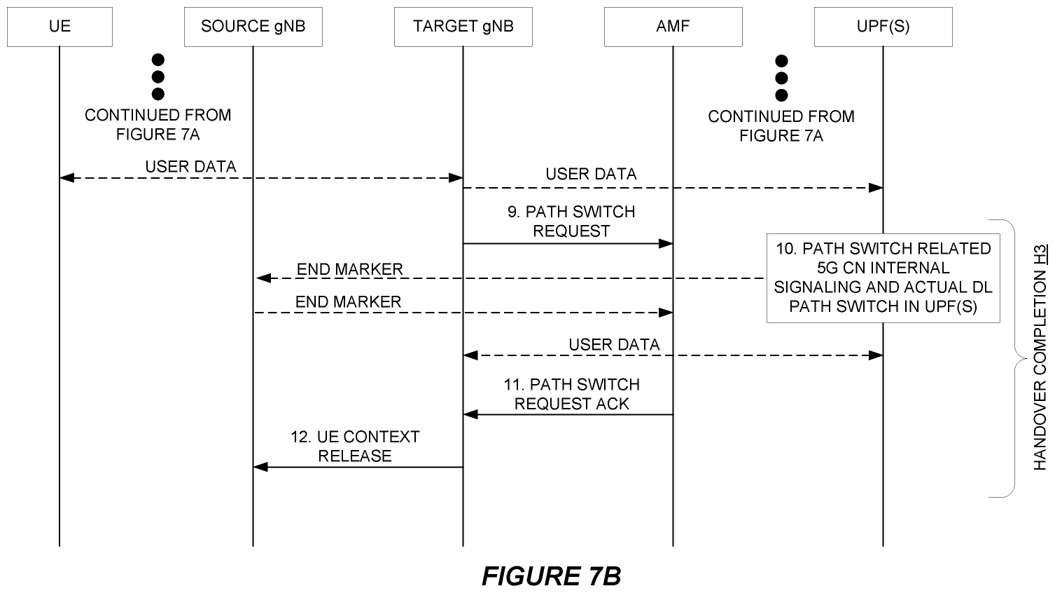

FIGS. 7A and 7B summarize the flow signalling between UE, source node and target node during a handover procedure.

As shown, the UE may be transmitting user data to and/or receiving user data from User Plane Function(s) via a source gNB. Handover preparation H1, handover execution H2, and handover completion H3 may thereafter proceed as follows.

Step 0. The UE context within the source gNB contains information regarding roaming and access restrictions which were provided either at connection establishment or at the last timing advance (TA) update.

Step 1. The source gNB configures the UE measurement procedures and the UE reports according to the measurement configuration.

Step 2. The source gNB decides to handover the UE, based on MeasurementReport and Radio Resource Management (RRM) information.

Step 3. The source gNB issues a Handover Request message to the target gNB passing a transparent RRC container with necessary information to prepare the handover at the target side. The information includes at least the target cell ID, KgNB*, the Cell Radio Network Temporary Identity (C-RNTI) of the UE in the source gNB, RRM-configuration including UE inactive time, basic AS-configuration including antenna Info and DL Carrier Frequency, the current QoS flow to Data Radio Bearer (DRB) mapping rules applied to the UE, the System Information Block #1 (SIB1) from source gNB, the UE capabilities for different Radio Access Technologies (RATs), Protocol Data Unit (PDU) session related information, and can include the UE reported measurement information including beam-related information if available. The PDU session related information includes the slice information (if supported) and QoS flow level QoS profile(s). NOTE: After issuing a Handover Request, the source gNB should not reconfigure the UE, including performing Reflective QoS flow to DRB mapping.

Step 4. Admission Control may be performed by the target gNB. Slice-aware admission control shall be performed if the slice information is sent to the target gNB. If the PDU sessions are associated with non-supported slices the target gNB shall reject such PDU Sessions.

Step 5. The target gNB prepares the handover with L1/L2 and sends the HANDOVER REQUEST ACKNOWLEDGE to the source gNB, which includes a transparent container to be sent to the UE as an RRC message to perform the handover.

Step 6. The source gNB triggers the Uu handover by sending an RRCReconfiguration message to the UE, containing the information required to access the target cell: at least the target cell ID, the new C-RNTI, the target gNB security algorithm identifiers for the selected security algorithms. It can also include a set of dedicated Random Access Channel (RACH) resources, the association between RACH resources and Synchronization Signal Block(s) (SSB(s)), the association between RACH resources and UE-specific Channel State Information Reference Signal (CSI-RS) configuration(s), common RACH resources, and system information of the target cell, etc.

Step 7. The source gNB sends the SN STATUS TRANSFER message to the target gNB.

The UE may then detach from the old cell and synchronize to the new cell. The source gNB may deliver buffered and in-transit user data to the target gNB, by forwarding that user data to the target gNB. The target gNB may buffer this user data from the source gNB.

Step 8. The UE synchronises to the target cell and completes the RRC handover procedure by sending RRCReconfigurationComplete message to target gNB.

At this point, the UE may transmit user data to and/or receive user data from the target gNB, but the target gNB may only transmit user data to the UPF(s). In order for the target gNB to be able to receive user data from the UPF(s) for the UE, the target gNB proceeds as follows.

Step 9. The target gNB sends a PATH SWITCH REQUEST message to Access and Mobility Function (AMF) to trigger 5G Core (5GC) to switch the downlink (DL) data path towards the target gNB and to establish an NG-C interface instance towards the target gNB.

Step 10. 5GC switches the DL data path towards the target gNB. The User Plane Function (UPF) sends one or more “end marker” packets on the old path to the source gNB per PDU session/tunnel and then can release any U-plane/TNL resources towards the source gNB. The source gNB may similarly send one or more “end marker” packets to the target gNB.

At this point, the target gNB may transmit user data to and receive user data from the UPF(s) for the UE.

Step 11. The AMF confirms the PATH SWITCH REQUEST message with the PATH SWITCH REQUEST ACKNOWLEDGE message.

Step 12. Upon reception of the PATH SWITCH REQUEST ACKNOWLEDGE message from the AMF, the target gNB sends the UE CONTEXT RELEASE to inform the source gNB about the success of the handover. The source gNB can then release radio and C-plane related resources associated to the UE context. Any ongoing data forwarding may continue.

Both in LTE and NR, some principles exist for handovers (or in more general terms, mobility in RRC_CONNECTED). Mobility in RRC_CONNECTED is network-based as the network has the best information regarding the current situation such as load conditions, resources in different nodes, available frequencies, etc. The network can also take into account the situation of many UEs in the network, for a resource allocation perspective. The network prepares a target cell before the UE accesses that cell. The source cell provides the UE with the RRC configuration to be used in the target cell, including SRB1 configuration to send handover (HO) complete. The UE is provided by the target cell with a target C-RNTI i.e. target identifies UE from Message 3 (MSG.3) on the Medium Access Control (MAC) level for the HO complete message. Hence, there is no context fetching, unless a failure occurs. To speed up the handover, the network provides needed information on how to access the target, e.g. Random Access Channel (RACH) configuration, so the UE does not have to acquire System Information (SI) prior to the handover. The UE may be provided with contention-free random access (CFRA) resources, i.e. in that case the target cell identifies the UE from the preamble (MSG.1). The principle behind this is that the procedure can always be optimized with dedicated resources. In conditional handover (CHO), that might be a bit tricky as there is uncertainty about the final target but also the timing. Security is prepared before the UE accesses the target cell i.e. Keys must be refreshed before sending RRC Connection Reconfiguration Complete message, based on new keys and encrypted and integrity protected so the UE can be verified in the target cell. Both full and delta reconfiguration are supported so that the HO command can be minimized.

Mobility will be enhanced in LTE and NR in 3GPP in release 16. The main objectives are to improve the robustness at handover and to decrease the interruption time at handover.

One problem related to robustness at handover is that the handover (HO) Command (RRCConnectionReconfiguration with mobilityControlInfo and RRCReconfiguration with a reconfigurationWithSync field) is normally sent when the radio conditions for the UE are already quite bad. That may lead to that the HO Command may not reach the UE in time if the message is segmented or there are retransmissions.

In LTE and NR, there may be different solutions to increase mobility robustness. One solution is called “conditional handover” or “early handover command”. In order to avoid the undesired dependence on the serving radio link upon the time (and radio conditions) where the UE should execute the handover, the possibility to provide RRC signaling for the handover to the UE earlier should be provided. To achieve this, it should be possible to associate the HO command with a condition e.g. based on radio conditions possibly similar to the ones associated to an A3 event, where a given neighbour becomes X db better than target. As soon as the condition is fulfilled, the UE executes the handover in accordance with the provided handover command.

Such a condition could e.g. be that the quality of the target cell or beam becomes X dB stronger than the the serving cell. The threshold Y used in a preceding measurement reporting event should then be chosen lower than the one in the handover execution condition. This allows the serving cell to prepare the handover upon reception of an early measurement report and to provide the RRCConnectionReconfiguration with mobilityControlInfo at a time when the radio link between the source cell and the UE is still stable. The execution of the handover is done at a later point in time (and threshold) which is considered optimal for the handover execution.

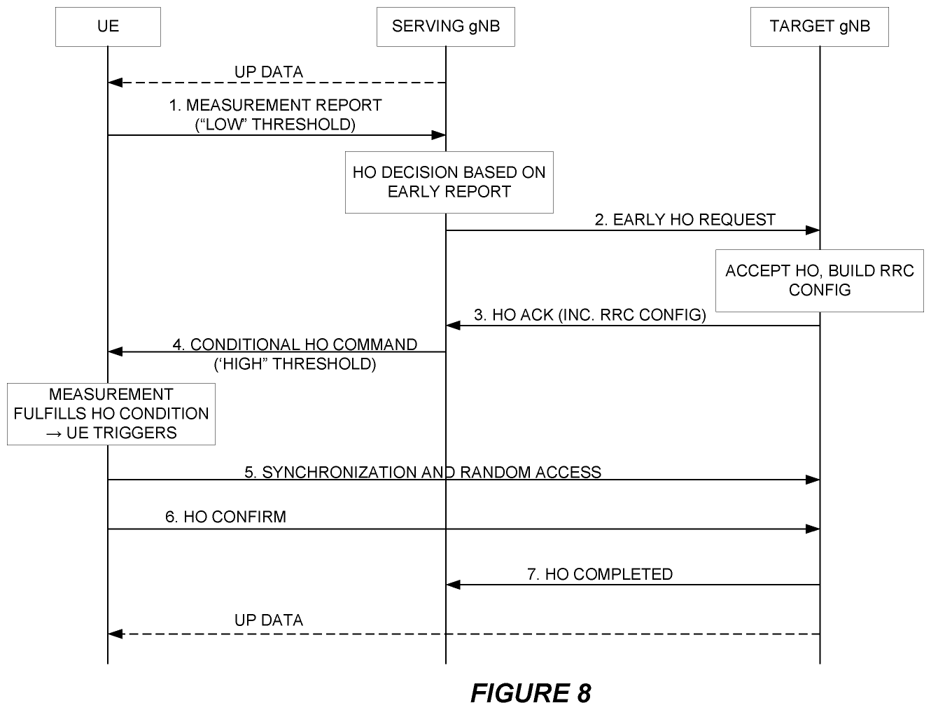

FIG. 8 depicts an example with a serving cell, a UE, and a target cell. In practice there may often be many cells or beams that the UE reported as possible candidates based on its preceding radio resource management (RRM) measurements. The network should then have the freedom to issue conditional handover commands for several of those candidates. The RRCConnectionReconfiguration for each of those candidates may differ, e.g. in terms of the HO execution condition (reference signal, RS, to measure and threshold to exceed) as well as in terms of the random access (RA) preamble to be sent when a condition is met.

While the UE evaluates the condition, it should continue operating per its current RRC configuration, i.e., without applying the conditional HO command. When the UE determines that the condition is fulfilled, it disconnects from the serving cell, applies the conditional HO command and connects to the target cell. These steps are equivalent to the current, instantaneous handover execution.

More particularly, in FIG. 8, the serving gNB may exchange user plane (UP) data with the UE. In step 1, the UE sends a measurement report with a “low” threshold to the serving gNB. The serving gNB makes a handover (HO) decision based on this early report. In step 2, the serving gNB sends an early HO request to a target gNB. The target gNB accepts the HO request and builds an RRC configuration. The target gNB returns a HO acknowledgement, including the RRC configuration, to the serving gNB in step 3. In step 4, a conditional HO command with a “high” threshold is sent to the UE. Subsequently, measurements by the UE may fulfil the HO condition of the conditional HO command. The UE thus triggers the pending conditional handover. The UE performs synchronization and random access with the target gNB in step 5, and HO confirm is exchanged in step 6. In step 7, the target gNB informs the serving gNB that HO is completed. The target gNB may then exchange user plane (UP) data with the UE.

Consider now radio link failure (RLF). At legacy handover, if the UE fails to connect to the new cell it can trigger an RRC connection re-establishment in any cell. The purpose is to try to re-establish the connection in a cell which may be better. If the connection fails in the current cell the UE can also trigger RLF by requesting an RRC connection reestablishment. When the UE needs to trigger a reestablishment it sends the message RRCConnectionReestablishmentRequest, the network replies with RRCConnectionReestablishment and the UE sends RRCConnectionReestablishmentComplete when the reestablishment is completed.

### RLF Report

When the UE has triggered Radio Link Failure (RLF) the network can request information from the UE about why RLF was triggered. That is done in the messages UEInformationRequest and UEInformationResponse.

| | |
|---|---|
| — | UEInformationRequest |

The UEInformationRequest is the command used by E-UTRAN to retrieve
information from the UE.
Signalling radio bearer: SRB1

RLC-SAP: AM
Logical channel: DCCH
Direction: E-UTRAN to UE

UEInformationRequest message
-- ASN1START

| | | |
|---|---|---|
| UEInformationRequest-r9 | ::= | SEQUENCE { |

| | |
|---|---|
| rrc-TransactionIdentifier | RRC-TransactionIdentifier, |
| criticalExtensions | CHOICE { |

| | |
|---|---|
| c1 | CHOICE { |

| | |
|---|---|
| ueInformationRequest-r9 | UEInformationRequest-r9-IEs, |

spare3 NULL, spare2 NULL, spare1 NULL

},

| | |
|---|---|
| criticalExtensionsFuture | SEQUENCE { } |

| | } | |
|---|---|---|
| } | | |
| UEInformationRequest-r9-IEs ::= | | SEQUENCE { |
| | rach-ReportReq-r9 | BOOLEAN, |
| | rlf-ReportReq-r9 | BOOLEAN, |
| | nonCriticalExtension | UEInformationRequest-v930-IEs |
| | OPTIONAL | |

}

UEInformationRequest-v930-IEs ::= SEQUENCE {

| | |
|---|---|
| lateNonCriticalExtension | OCTET STRING |
| OPTIONAL, | |
| nonCriticalExtension | UEInformationRequest-v1020-IEs |
| OPTIONAL | |

}

UEInformationRequest-v1020-IEs ::= SEQUENCE {

| | |
|---|---|
| logMeasReportReq-r10 | ENUMERATED {true} |

| | |
|---|---|
| OPTIONAL, | -- Need ON |

| | |
|---|---|
| nonCriticalExtension | UEInformationRequest-v1130-IEs |
| OPTIONAL | |

}

UEInformationRequest-v1130-IEs ::= SEQUENCE {

| | |
|---|---|
| connEstFailReportReq-r11 | ENUMERATED {true} |

| | |
|---|---|
| OPTIONAL, | -- Need ON |

| | |
|---|---|
| nonCriticalExtension | UEInformationRequest-v1250-IEs |
| OPTIONAL | |

}

UEInformationRequest-v1250-IEs ::= SEQUENCE {

| | |
|---|---|
| mobilityHistoryReportReq-r12 | ENUMERATED {true} |

| | |
|---|---|
| OPTIONAL, | -- Need ON |

| | |
|---|---|
| nonCriticalExtension | UEInformationRequest-v1530-IEs |
| OPTIONAL | |

}

UEInformationRequest-v1530-IEs ::= SEQUENCE {

| | |
|---|---|
| idleModeMeasurementReq-r15 | ENUMERATED {true} |

| OPTIONAL, | -- Need ON | |
|---|---|---|
| flightPathInfoReq-r15 | | FlightPathInfoReportConfig-r15 |
| OPTIONAL, | -- Need ON | |

| | |
|---|---|
| nonCriticalExtension | SEQUENCE { } |
| OPTIONAL | |

}
-- ASN1STOP

UEInformationRequest field descriptions
rach-ReportReq
This field is used to indicate whether the UE shall report information about the
random access procedure.

UEInformationResponse

The UEInformationResponse message is used by the UE to transfer the information requested by the E-UTRAN.
Signalling radio bearer: SRB1 or SRB2 (when logged measurement information is included)
RLC-SAP: AM
Logical channel: DCCH
Direction: UE to E-UTRAN

UEInformationResponse message

-- ASN1START

| | |
|---|---|
| UEInformationResponse-r9-IEs ::= | SEQUENCE { |

| | |
|---|---|
| rach-Report-r9 | SEQUENCE { |

| | |
|---|---|
| numberOfPreamblesSent-r9 | NumberOfPreamblesSent-r11, |

| | |
|---|---|
| contention Detected-r9 | BOOLEAN |

| } | | OPTIONAL, |
|---|---|---|
| rlf-Report-r9 | RLF-Report-r9 | OPTIONAL, |

| | |
|---|---|
| nonCriticalExtension | UEInformationResponse-v930-IEs |

OPTIONAL

}
-- Late non critical extensions

UEInformationResponse-v9e0-IEs ::= SEQUENCE {

| | |
|---|---|
| rlf-Report-v9e0 | RLF-Report-v9e0 |
| OPTIONAL, | |
| nonCriticalExtension | SEQUENCE { } |
| OPTIONAL | |

}
[...]

| | |
|---|---|
| RLF-Report-r9 ::= | SEQUENCE { |

| | |
|---|---|
| measResultLastServCell-r9 | SEQUENCE { |

| | |
|---|---|
| rsrpResult-r9 | RSRP-Range, |
| rsrqResult-r9 | RSRQ-Range |

OPTIONAL
},
[...]

| | |
|---|---|
| connectionFailureType-r10 | ENUMERATED {rlf, hof} |

OPTIONAL,

[...]

| | |
|---|---|
| ]], | |
| [[ basicFields-r11 | SEQUENCE { |

| | |
|---|---|
| c-RNTI-r11 | C-RNTI, |
| rlf-Cause-r11 | ENUMERATED { |

t310-Expiry, randomAccessProblem,
rlc-MaxNumRetx, t312-Expiry-r12},

| | |
|---|---|
| timeSinceFailure-r11 | TimeSinceFailure-r11 |

}

OPTIONAL,

[...]

}

| | |
|---|---|
| RLF-Report-v9e0 ::= | SEQUENCE { |

| | |
|---|---|
| measResultListEUTRA-v9e0 | MeasResultList2EUTRA-v9e0 |

}
[...]

| | |
|---|---|
| MeasResultList2EUTRA-v9e0 ::= | SEQUENCE (SIZE (1..maxFreq)) OF |

MeasResult2EUTRA-v9e0
[...]
}

| MeasResult2EUTRA-v9e0 ::= | | SEQUENCE { |
|---|---|---|
| | carrierFreq-v9e0 | ARFCN-ValueEUTRA-v9e0 |

OPTIONAL

}
[...]
-- ASN1STOP

UEInformationResponse field descriptions
absoluteTimeStamp
Indicates the absolute time when the logged measurement configuration logging is
provided, as indicated by E-UTRAN within absoluteTimeInfo.
anyCellSelectionDetected
This field is used to indicate the detection of any cell selection state, as defined in TS
36.304 [4]. The UE sets this field when performing the logging of measurement results in
RRC_IDLE and there is no suitable cell or no acceptable cell.
bler
Indicates the measured BLER value. The coding of BLER value is defined in TS 36.133
[16].
blocksReceived
Indicates total number of MCH blocks, which were received by the UE and used for the
corresponding BLER calculation, within the measurement period as defined in TS 36.133
[16].
UEInformationResponse field descriptions
carrierFreq
In case the UE includes carrierFreq-v9e0 and/ or carrierFreq-v1090, the UE shall set the
corresponding entry of carrierFreq-r9 and/ or carrierFreq-r10 respectively to maxEARFCN.
For E-UTRA and UTRA frequencies, the UE sets the ARFCN according to the band used
when obtaining the concerned measurement results.
connectionFailureType
This field is used to indicate whether the connection failure is due to radio link failure or
handover failure.
contentionDetected
This field is used to indicate that contention was detected for at least one of the transmitted
preambles, see TS 36.321 [6].
c-RNTI
This field indicates the C-RNTI used in the PCell upon detecting radio link failure or the C-
RNTI used in the source PCell upon handover failure.
dataBLER-MCH-ResultList
Includes a BLER result per MCH on subframes using dataMCS, with the applicable
MCH(s) listed in the same order as in pmch-InfoList within MBSFNAreaConfiguration.
drb-EstablishedWithQCI-1
This field is used to indicate the radio link failure occurred while a bearer with QCI value
equal to 1 was configured, see TS 24.301 [35].
failedCellId
This field is used to indicate the cell in which connection establishment failed.
failedPCellId
This field is used to indicate the PCell in which RLF is detected or the target PCell of the
failed handover. The UE sets the EARFCN according to the band used for transmission/
reception when the failure occurred.
inDeviceCoexDetected
Indicates that measurement logging is suspended due to IDC problem detection.
logMeasResultListBT
This field refers to the Bluetooth measurement results.
logMeasResultListWLAN
This field refers to the WLAN measurement results.
maxTxPowerReached
This field is used to indicate whether or not the maximum power level was used for the last
transmitted preamble, see TS 36.321 [6].
UEInformationResponse field descriptions
mch-Index
Indicates the MCH by referring to the entry as listed in pmch-InfoList within
MBSFNAreaConfiguration.
[...]
rlf-Cause
This field is used to indicate the cause of the last radio link failure that was detected. In
case of handover failure information reporting (i.e., the connectionFailureType is set to
′hof′), the UE is allowed to set this field to any value.
[...]

The RLF report contains various types of information related to the failure, e.g. which cell the UE failed in, measurements for that cell and other types of information that the network might need. It also contains information about if the failure was triggered at handover or at RLF in the current cell and the cause value for the RLF.

There currently exist certain challenge(s). In the case of handover failure, an RLF report logs information associated to the time and location where the failure has occurred. Then, when the UE re-connects to the network (e.g. via re-establishment) the UE includes an indication that it has an RLF report available. After receiving that information, the target node may request the UE to report the stored RLF report logged due to handover failure. Upon receiving the report, the target may provide that information to the source and the source may tune parameters associated to the triggering of measurement reports. For example, an RLF may have been triggered because the triggering point for an A3 event was too low i.e. a too late handover has occurred.

Existing messages (i.e. UEInformationRequest and UEInformationResponse) contain information that is relevant for existing procedures, such as handover failures and RLF, but not for conditional handover. It is nonetheless useful for the network to know that a conditional handover has failed and the reason for it as such information can be taken into account for future configurations of conditional handover.

Certain aspects of the present disclosure and their embodiments may provide solutions to these or other challenges. Some embodiments comprise a method for the UE to indicate various types of failures related to conditional handover. The method comprises indicating information associated to at least one of the following failure cases related to conditional handover procedures, such as:
Failure in connecting to the target cell at conditional handover.
RLF while conditional handover (CHO) is being monitored.
Inability to comply with the CHO configuration upon handover execution.
Inability to comply with the CHO configuration.
Etc.

Some embodiments therefore generally provide the possibility for the UE to report failure of a conditional handover.

Certain embodiments may provide one or more of the following technical advantage(s). If conditional handover fails for some reason, it is beneficial for the network to know the reason for the failure in order to improve future configurations of conditional handover. Some embodiments comprise possible ways for the UE to signal different reasons for conditional handover failure.

More particularly, a UE configured with a set of conditional RRCReconfiguration(s) shall execute a handover (or conditional handover, depending how the procedure is going to be called in NR RRC specifications) when the condition for the handover is fulfilled. As used herein, the term conditional handover related configuration(s) may be for a cell, list of cell(s), measurement object(s) or frequencies. In the case of the cell association, they may be for the same radio access technology (RAT) or for a different RAT.

The term “conditional handover related configuration(s)” for a cell may comprise the following:
An RRCReconfiguration like message (or any message with equivalent content), possibly containing a reconfigurationWithSync using NR terminology (defined in 38.331 specifications) and prepared by target candidates. Or, using the E-UTRA terminology, an RRCConnectionReconfiguration with mobilityControlInfo (defined in 36.331 specifications);
Triggering condition(s) configuration e.g. something like A1-A6 or B1-B2 (inter-RAT events) triggering events (as defined in 38.331/36.331 in reportConfig) where instead of triggering a measurement report it would trigger a conditional handover;
Other (optionally) conditional handover controlling parameters e.g. timer defining the validity of target candidate resources, etc.

Note that the term handover or reconfiguration with sync may be used herein with a similar meaning. Hence, a conditional handover may also be called a conditional reconfiguration with sync. In NR terminology, the handovers are typically called an RRCReconfiguration with a reconfigurationWithSync (field containing configuration necessary to execute a handover, like target information such as frequency, cell identifier, random access configuration, etc.). In E-UTRA terminology, the handovers are typically called an RRCConnectionReconfiguration with a mobilityControlInfo (field containing configuration necessary to execute a handover).

Most of the UE (and network) actions defined herein and network configurations are described as being performed in NR or E-UTRA. In other words, the configuration of a conditional HO received in NR for NR cells, and the UE may fail while monitoring these conditions and possibly try to re-connect after selecting an NR cell (e.g. via re-establishment).

However, embodiments herein are also applicable when any of these steps occurs in different RATs, for example:
UE is configured with a conditional HO in E-UTRA (for candidate NR and E-UTRA cells), UE fails in E-UTRA, but UE re-connects in E-UTRA;
UE is configured with a conditional HO in NR (for candidate NR and LTE cells), UE fails in NR, but UE re-connects in E-UTRA;
UE is configured with a conditional HO in E-UTRA (for candidate NR and E-UTRA cells), UE fails in E-UTRA, but UE re-connects in NR;
Or, in more general terms, UE is configured with a condition HO in RAT-1 for cells in RAT-1 or RAT-2, the UE fails in RAT-1, but the UE re-connects in RAT-2.

Below are different failure cases that may occur during conditional handover related procedure such as while the UE is monitoring at least one configured triggering condition based on measurements. According to some embodiments, when such failure is detected, the UE logs information associated to the failure and may possibly report to the network, so that the network can try to avoid such failure with other CHO configurations.

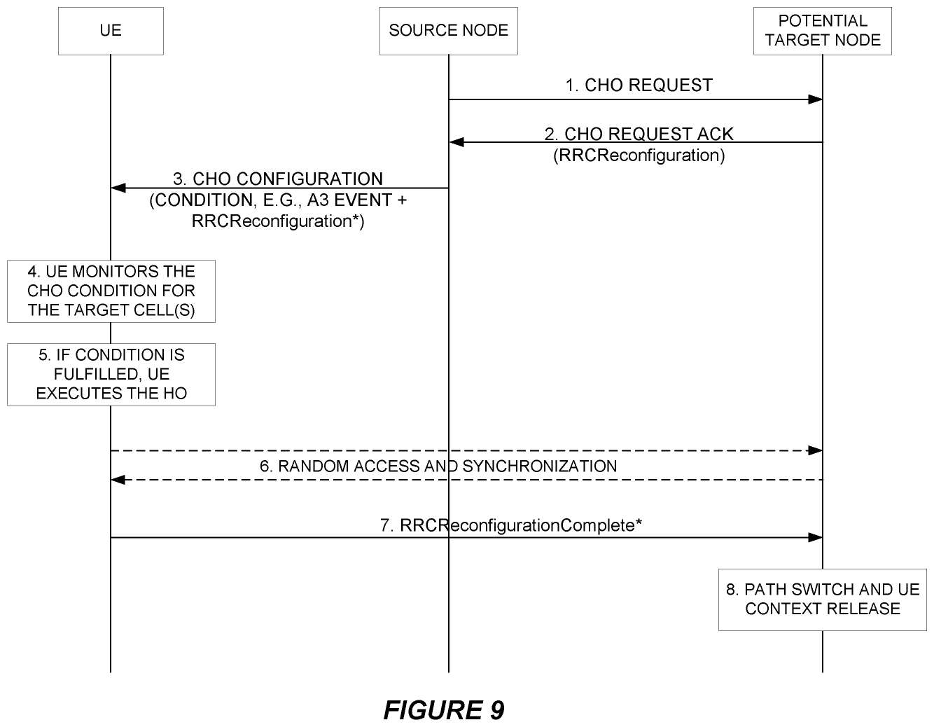

In conditional handover, the network configures the UE with triggering conditions for when a conditional handover should be executed. When the conditions are fulfilled, the UE executes the handover without any further order from the network. The advantage of the procedure is that the HO Command may be provided to the UE at an earlier stage before the radio conditions have become poor, which increases the chance of a successful transmission of the message. The basic signalling flow for conditional handover (CHO) is shown in FIG. 9.

As shown, the source node sends a CHO request to a potential target node (Step 1). The potential target node returns a CHO request acknowledgement back to the source node, including an RRCReconfiguration message prepared by the potential target node (Step 2). The source node may thereafter send a CHO configuration to the UE, including the prepared RRCReconfiguration as well as a condition associated with the RRCReconfiguration (Step 3). The UE then monitors the condition for the target cell(s) (Step 4). If a condition is fulfilled (Step 5), the UE executes the CHO. In particular, the UE performs random access and synchronization (Step 6) towards the potential target node and transmits an RRCReconfigurationComplete to the target node (Step 7). The target node then performs a path switch and UE context release for the UE (Step 8).

### CHO Configuration to the UE

In NR, the source receives the configuration prepared by the target and provides the configuration to the UE in an RRCReconfiguration message containing a reconfigurationWithSync field with instructions for the UE to access the target cell e.g. random access channel (RACH) parameters, cell identity, frequency, SMTC configuration, etc. Here, SMTC refers to a synchronization signal block (SSB) measurement time configuration. In CHO, similar information needs to be provided to the UE for a target candidate. In addition, the UE also needs the triggering condition associated to it e.g. an A3 event like configuration, so that the provided configuration is only applied if/when the condition is fulfilled.

In some embodiments, the baseline operation for E-UTRAN and/or NR Conditional HO procedure assumes a HO command type of message contains HO triggering condition(s) and dedicated RRC configuration(s). The UE in this case accesses the prepared target when the relevant condition is met.

Upon reception of the CHO configuration, the UE starts to monitor the triggering conditions, which is equivalent to the monitoring of triggering conditions for measurement reporting e.g. performing measurements for an A3 like event.

### Failure to Connect to the Target Cell at Execution of Conditional Handover

A first failure case is that the UE fails to connect to the target cell which fulfilled the conditions for conditional handover and to which the UE attempts to handover to. In one embodiment the UE starts a timer Txxx when the condition in a CHO has been fulfilled, and if the handover has not successfully completed upon expiry of Txxx, the conditional handover is considered failed.

The problems that may occur when the UE accesses the new cell are e.g. random access problems, timer T304 or equivalent Txxx may expire (timer for supervising execution of the handover). Random access problems may include for instance no random access response received within a random access (RA) response window, no received random access response contains a random access preamble identifier corresponding to the transmitted random access preamble, unsuccessful contention resolution, etc.

The UE should be able to report such problems as random access problems, expiration of T304, expiration of Txxx, etc. A new connectionFailureType e.g. {chof} is introduced in some embodiments. The failure type may be used in combination with a cause value, e.g. any of the existing causes (t310-Expiry, randomAccessProblem, rlc-MaxNumRetx, t312-Expiry-r12) or a new cause value e.g. t304-Expiry, or txxx-Expiry. See ASN.1 proposals below.

5.3.5.8.3 T304 expiry (Reconfiguration with sync Failure)
The UE shall:
   1> if T304 of the MCG expires:
      2> release dedicated preambles provided in rach-ConfigDedicated if configured;
      2> revert back to the UE configuration used in the source PCell;
      2> initiate the connection re-establishment procedure as specified in subclause 5.3.7.
   NOTE 1: In the context above, “the UE configuration” includes state variables and parameters of each radio bearer.
   1> else if T304 of a secondary cell group expires:
      2> release dedicated preambles provided in rach-ConfigDedicated, if configured;
      2> initiate the SCG failure information procedure as specified in subclause 5.7.3 to report SCG reconfiguration with sync failure, upon which the RRC reconfiguration procedure ends;
   1> else if T304 expires when RRCReconfiguration is received via other RAT (HO to NR failure):
      2> reset MAC;
      2> perform the actions defined for this failure case as defined in the specifications applicable for the other RAT.
   1> else if T304 expires during a conditional handover execution:
      2> release dedicated preambles provided in rach-ConfigDedicated if configured;
      2> revert back to the UE configuration used in the source PCell;
      2> store the following handover failure information in VarRLF-Report by setting its fields as follows:
         3> clear the information included in VarRLF-Report, if any;
         3> set the plmn-IdentityList to include the list of EPLMNs stored by the UE (i.e. includes the RPLMN);
         3> set the measResultLastServCell to include the RSRP and RSRQ, if available, of the source PCell based on measurements collected up to the moment the UE detected handover failure and in accordance with the following;
            4> if the UE includes rsrqResult, include the lastServCelIRSRQ-Type;
         3> set the measResultNeighCells to include the best measured cells, other than the source PCell, ordered such that the best cell is listed first, and based on measurements collected up to the moment the UE detected handover failure, and set its fields as follows;
            4> if the UE was configured to perform measurements for one or more EUTRA frequencies, include the measResultListEUTRA;
            4> if the UE includes rsrqResult, include the rsrq-Type;
            4> if the UE was configured to perform measurement reporting for one or more neighbouring UTRA frequencies, include the measResultListUTRA;
            4> if the UE was configured to perform measurement reporting for one or more neighbouring GERAN frequencies, include the measResultListGERAN;
            4> if the UE was configured to perform measurement reporting for one or more neighbouring CDMA2000 frequencies, include the measResultsCDMA2000;
            4> for each neighbour cell included, include the optional fields that are available;
      2> perform cell selection and, if selected cell is a cell for which the UE has stored a CHO configuration
         3> apply the stored RRCReconfiguration and perform actions as specified in 5.3.5.3 and delete the other stored CHO related configurations;
      2> else, if selected cell is not a cell for which the UE has stored a CHO configuration
         3> initiate the connection re-establishment procedure as specified in 5.3.7.

Expiry of the timer Txxx after the UE tries to access a target cell candidate would lead to a handover failure. Upon declaration of such failure, the UE would first select a suitable cell to only then transmit an RRCReconfigurationRequest. But then, in the case of CHO, if the UE selects a cell for which it has a stored RRCReconfiguration with reconfigurationWithSync, it would be much simpler, faster and efficient to apply the stored RRCReconfiguration with reconfigurationWithSync and complete the CHO compared to reverting the configuration and transmit an RRCReestablishment request. Accordingly, in some embodiments, upon Txxx expiry, the UE executes CHO if it selects a cell for which it has a stored CHO configuration.

RLF while Conditional Handover is being Monitored

In LTE and NR, RLF is declared when the timer T310 expires. The timer is started when upper layers detect that the downlink quality is below an acceptable level controlled by indications provided by lower layers.

At conditional handover, the network may likely configure the triggering conditions so that the handover will occur when the radio conditions of the PCell are not good any longer. That means that RLF may be declared when the UE is monitoring CHO triggering conditions (i.e. timer T310 may expire while the UE is monitoring CHO trigger conditions). Hence in some embodiments, upon that event of RLF declaration while the UE is monitoring CHO triggering conditions, the UE also considers this a CHO failure and logs information related to that in a report. There could be a specific failure case indicating the event, e.g. RLF while CHO being monitored. The UE may also include in the log to be reported measurements associated to the cells the UE was monitoring for CHO or to cells in the same frequencies as the ones being monitored (as these may be future candidates for future CHO configurations, depending on their radio conditions). The reporting of such a failure case could e.g. be done by reporting a new connectionFailureType like {chof} together with the existing cause value t310-Expiry or t312-Expiry-r12.

In some embodiments, upon that event of RLF declaration while the UE is monitoring CHO, the UE does not initiate re-establishment (as in RLF declaration after security is activated and without the UE monitoring CHO conditions) but instead selects a suitable cell and, if the UE has stored a CHO configuration (e.g. an RRCReconfiguration or equivalent content) for the selected cell, the UE performs CHO execution towards that cell e.g. by applying the stored RRCReconfiguration like message and, consequently, sending an RRCReconfigurationComplete. In that case, even if the RLF led to a sub-sequent successful conditional handover, the UE logs the failure information (as in an RLF report) and include in the RRCReconfigurationComplete message an indication that a failure report is available, for the network may request it.

In another alternative, upon detecting RLF while the UE is monitoring CHO triggering conditions (i.e. and has stored RRCReconfiguration(s) for potential target cells, the UE discards the CHO information and performs re-establishment

The first alternative may be modeled as the following in the specifications:

### 5.3.10.3 Detection of Radio Link Failure

The UE shall:
   1> upon T310 expiry in PCell; or
   1> upon random access problem indication from MCG MAC while neither T300, T301, T304, T311 nor T319 are running; or
   1> upon indication from MCG RLC that the maximum number of retransmissions has been reached:
      2> if CA duplication is configured and activated; and for the corresponding logical channel allowedServingCells only includes SCell(s):
         3> initiate the failure information procedure as specified in 5.7.5 to report RLC failure.
      2> else:
         3> consider radio link failure to be detected for the MCG i.e. RLF;
         3> store the following radio link failure information in the VarRLF-Report by setting its fields as follows:
            4> clear the information included in VarRLF-Report, if any;
            4> if the RLF occurred while CHO was being monitored, include in the report an indication that the RLF occurred while CHO was being monitored, the cell identifiers for the cells being monitored, available measurements for the cells being monitored (e.g. RSRP, RSRQ, SIN R, etc.) and other information related to CHO monitoring when the RLF was declared;
         3> if AS security has not been activated:
            4> perform the actions upon going to RRC_IDLE as specified in 5.3.11, with release cause ‘other’;
         3> else if AS security has been activated but SRB2 and at least one DRB have not been setup:
            4> perform the actions upon going to RRC_IDLE as specified in 5.3.11, with release cause ‘RRC connection failure’;
         3> if security has been activated and CHO is configured (i.e. UE is monitoring CHO trigger conditions):
            4> perform cell selection and, if selected cell is a cell for which the UE has stored a CHO configuration:
            5> apply the stored RRCReconfiguration and perform actions as specified in 5.3.5.3 and delete the other stored CHO related configurations;
            4> else, if selected cell is not a cell for which the UE has stored a CHO configuration:
            5> initiate the connection re-establishment procedure as specified in 5.3.7.

RRCReconfigurationComplete

The RRCReconfigurationComplete message is used to confirm the successful completion of an RRC connection reconfiguration.

Signalling radio bearer: SRB1 or SRB3

RLC-SAP: AM

Logical channel: DCCH

Direction: UE to Network

RRCReconfigurationComplete message

-- ASN1START
-- TAG-RRCRECONFIGURATIONCOMPLETE-START

| | |
|---|---|
| RRCReconfigurationComplete ::= | SEQUENCE { |

| | |
|---|---|
| rrc-TransactionIdentifier | RRC-TransactionIdentifier, |

| | |
|---|---|
| criticalExtensions | CHOICE { |

| | |
|---|---|
| rrcReconfigurationComplete | RRCReconfigurationComplete-IEs, |

| | |
|---|---|
| criticalExtensionsFuture | SEQUENCE { } |

}

}

| | |
|---|---|
| RRCReconfigurationComplete-IEs ::= | SEQUENCE { |

| | |
|---|---|
| lateNonCriticalExtension | OCTET STRING |

| OPTIONAL, | | |
|---|---|---|
| | nonCriticalExtension | RRCReconfigurationComplete-v1530-IEs |

OPTIONAL
}

RRCReconfigurationComplete-v1530-IEs ::= SEQUENCE {

| | |
|---|---|
| uplinkTxDirectCurrentList | UplinkTxDirectCurrentList |

OPTIONAL,

// used for RLF declaration while CHO monitoring is running

| | | |
|---|---|---|
| rlf-InfoAvailable-r9 | ENUMERATED {true} | OPTIONAL, |

| | |
|---|---|
| nonCriticalExtension | SEQUENCE { } |

OPTIONAL
}

-- TAG-RRCRECONFIGURATIONCOMPLETE-STOP
-- ASN1STOP

Inability to Comply with the CHO Configuration

In some embodiments, a conditional handover (CHO) configuration consists of one configuration that is applied immediately and one or many configurations for the target cell which is applied when the conditional handover is executed. The configuration to be applied immediately is the configuration for monitoring the conditions for conditional handover, also referred to as a triggering condition configuration. The compliance with that configuration is checked immediately upon receiving the message. The configuration for a target cell may also be referred to as a dedicated RRC configuration prepared by the target cell, e.g., with content equivalent to an RRCReconfiguration with reconfigurationWithSync. The ability to comply with the configuration in the target cell may be checked directly when receiving the message (case B) or when executing the actual handover (case A). The UE actions when not complying with the target configuration may be different depending on if the UE checks the compliance with the configuration upon reception of the message or upon execution of the handover.

Inability to Comply with the CHO Configuration Upon Handover Execution

Here the UE has been configured with CHO i.e. the UE has stored at least one RRCReconfiguration including a reconfigurationWithSync (or equivalent content) and an associated triggering condition, and upon receiving that configuration it monitors the fulfillment of the condition based on measurements. In this case, then, the UE can comply with the CHO configuration(s), or at least with the trigger condition configurations, that are immediately applied and this leads to UE actions upon reception. In particular, upon receiving the HO triggering condition(s) and dedicated RRC configuration(s), the UE starts to perform the monitoring of the trigger conditions (which involves the UE performing measurements).

When at least one cell fulfills the conditions, the UE triggers a conditional handover execution. Note though that multiple target cell candidates may be configured i.e. the UE may have stored one or multiple dedicated RRC configuration (e.g. multiple RRCReconfiguration(s) with reconfigurationWithSync(s)) and multiple trigger condition configuration(s). If one of these conditions are triggered, the UE performs the CHO execution which should be similar to a handover execution i.e. it consists of starting the timer T304 (or equivalent) and applying the stored RRCReconfiguration with reconfigurationWithSync message associated to the target cell candidate for which the trigger condition has been fulfilled.

When applying the message, which would be equivalent to having received at that moment an RRCReconfiguration with reconfigurationWithSync, the UE may be unable to comply with (part of) the configuration prepared by that target candidate. As one observation, then, upon CHO execution, a UE may be unable to comply with a dedicated configuration from a target candidate.

In this case (case A), the UE has not checked the compliance with the target configuration when receiving the configuration of the conditional handover, but checks it when the handover is actually executed. When the handover is actually executed the UE may fail to connect to the new cell if it is not able to comply with the configuration for the target cell (received when conditional handover was configured, i.e. the RRCReconfiguration prepared by target). In this case the UE may need to trigger an RRC reestablishment as there is not enough time to send any new configuration to the UE. Accordingly, in one embodiment, if the UE declares CHO failure (not able to comply with CHO configuration) the UE initiates connection re-establishment.

Again, e.g. a new connectionFailureType for {chof} could be used in the report, possibly in combination with new cause values, e.g. incompatibleTargetConfig. An RRC reestablishment with this new connectionFailureType is one example implementation for the message 28 in FIG. 1. See ASN.1 proposals below.

In some embodiments, though, upon the event of inability to comply with a CHO at execution, the UE does not have to initiate re-establishment (as in RLF declaration after security is activated and without the UE monitoring CHO conditions) but may instead select a suitable cell and, if the UE has stored a CHO configuration (e.g. an RRCReconfiguration or equivalent content) for the selected cell, the UE may perform CHO execution towards that cell e.g. by applying the stored RRCReconfiguration like message and, consequently, sending an RRCReconfigurationComplete. In that case, even if the inability to comply led to a sub-sequent successful conditional handover, the UE logs the failure information (as in an RLF report) and include in the RRCReconfigurationComplete message an indication that a failure report is available, for the network may request it.

5.3.5.8.2 Inability to Comply with RRCReconfiguration
The UE shall:
   1> if the UE is operating in EN-DC:
      2> if the UE is unable to comply with (part of) the configuration included in the RRCReconfiguration message received over SRB3;
         3> continue using the configuration used prior to the reception of RRCReconfiguration message;
         3> initiate the SCG failure information procedure as specified in subclause 5.7.3 to report SCG reconfiguration error, upon which the connection reconfiguration procedure ends;
      2> else, if the UE is unable to comply with (part of) the configuration included in the RRCReconfiguration message received over SRB1;
         3> continue using the configuration used prior to the reception of RRCReconfiguration message;
         3> initiate the connection re-establishment procedure as specified in TS 36.331 [10], clause 5.3.7, upon which the connection reconfiguration procedure ends.
   1> else if RRCReconfiguration is received via NR:
      2> if the UE is unable to comply with (part of) the configuration included in the RRCReconfiguration message;
         3> continue using the configuration used prior to the reception of RRCReconfiguration message;
         3> if security has not been activated:
            4> perform the actions upon going to RRC_IDLE as specified in 5.3.11, with release cause ‘other’
         3> else if AS security has been activated but SRB2 and at least one DRB have not been setup:
            4> perform the actions upon going to RRC_IDLE as specified in 5.3.11, with release cause ‘RRC connection failure’;
         3> else:
            4> initiate the connection re-establishment procedure as specified in 5.3.7, upon which the reconfiguration procedure ends;
   1> else if RRCReconfiguration is received via other RAT (Handover to NR failure):
      2> if the UE is unable to comply with any part of the configuration included in the RRCReconfiguration message:
         3> perform the actions defined for this failure case as defined in the specifications applicable for the other RAT.
   NOTE 1: The UE may apply above failure handling also in case the RRCReconfiguration message causes a protocol error for which the generic error handling as defined in 10 specifies that the UE shall ignore the message.
   NOTE 2: If the UE is unable to comply with part of the configuration, it does not apply any part of the configuration, i.e. there is no partial success/failure.
   1> else if the RRCReconfiguration is received as part of a CHO configuration:
      2> if the UE is unable to comply with (part of) the configuration:
         3> continue using the configuration used prior to the reception of RRCReconfiguration message;
         3> if security has not been activated:
            4> perform the actions upon going to RRC_IDLE as specified in 5.3.11, with release cause ‘other’
         3> else if AS security has been activated but SRB2 and at least one DRB have not been setup:
            4> perform the actions upon going to RRC_IDLE as specified in 5.3.11, with release cause ‘RRC connection failure’;
         3> if security has been activated and CHO is configured (i.e. UE is monitoring CHO trigger conditions):
            4> perform cell selection and, if selected cell is a cell for which the UE has stored a CHO configuration:
            5> clear the information included in VarRLF-Report, if any;
            5> store the following radio link failure information in the VarRLF-Report by setting its fields as follows:
            6> if the inability to comply occurred for CHO configurations, include in the report an indication of the cell(s) associated to the configuration that was not compliant, the cell identifiers for the cells being monitored, available measurements for the cells being monitored (e.g. RSRP, RSRQ, SINR, etc.) and other information related to CHO;
            5> apply the stored RRCReconfiguration and perform actions as specified in 5.3.5.3 and delete the other stored CHO related configurations;
            4> else, if selected cell is not a cell for which the UE has stored a CHO configuration:
            5> initiate the connection re-establishment procedure as specified in 5.3.7, upon which the reconfiguration procedure ends.

Generally, then, in NR, as in LTE, non-compliance with dedicated RRC configuration(s) upon CHO execution would lead to a reconfiguration failure. And, upon declaration of such a failure, the UE would first select a suitable cell to only then transmit an RRCReconfigurationRequest. But then, in the case of CHO, if the UE selects a cell for which it has a stored RRCReconfiguration with reconfigurationWithSync, it would be much simpler, faster and efficient to apply the stored RRCReconfiguration with reconfigurationWithSync and complete the CHO compared to reverting the configuration and transmit an RRCReestablishment request. Accordingly, in some embodiments, upon non-compliance of a dedicated RRC configuration of a target cell in CHO, the UE executes CHO if it selects a cell for which it has a stored CHO configuration.

Inability to Comply with the CHO Configuration Upon Reception of CHO Configuration

When the UE receives a conditional handover configuration it may not be able to comply with that configuration for conditional handover. It could be that the UE cannot comply with the actual conditional handover configuration, e.g. there is something wrong with the triggering conditions.

It could also be that the UE checks the compliance with the target configuration (the configuration to be used in the target node after the handover) already when receiving the CHO configuration (case B). In such case, it is not necessary for the UE to trigger a reestablishment as the radio conditions may still be good enough to solve the incompliance and instead indication regarding the failure could be reported to the network. In this case, the UE is not able to comply with an RRCReconfiguration from a specific target, out of a possible set of other RRCReconfiguration(s) in the CHO configuration. Hence, the UE may include in the log i.e. to be included in the failure report, information about the failed message, or the failed cell associated to the message.

5.3.5.8.2 Inability to Comply with RRCReconfiguration
The UE shall:
   1> if the UE is operating in EN-DC:
      2> if the UE is unable to comply with (part of) the configuration included in the RRCReconfiguration message received over SRB3;
         3> continue using the configuration used prior to the reception of RRCReconfiguration message;
         3> initiate the SCG failure information procedure as specified in subclause 5.7.3 to report SCG reconfiguration error, upon which the connection reconfiguration procedure ends;
      2> else, if the UE is unable to comply with (part of) the configuration included in the RRCReconfiguration message received over SRB1;
         3> continue using the configuration used prior to the reception of RRCReconfiguration message;
         3> initiate the connection re-establishment procedure as specified in TS 36.331 [10], clause 5.3.7, upon which the connection reconfiguration procedure ends.
   1> else if RRCReconfiguration is received via NR:
      2> if the UE is unable to comply with (part of) the configuration included in the RRCReconfiguration message;
         3> continue using the configuration used prior to the reception of RRCReconfiguration message;
         3> if security has not been activated:
            4> perform the actions upon going to RRC_IDLE as specified in 5.3.11, with release cause ‘other’
         3> else if AS security has been activated but SRB2 and at least one DRB have not been setup:
            4> perform the actions upon going to RRC_IDLE as specified in 5.3.11, with release cause ‘RRC connection failure’;
         3> else:
            4> initiate the connection re-establishment procedure as specified in 5.3.7, upon which the reconfiguration procedure ends;
   1> else if RRCReconfiguration is received via other RAT (Handover to NR failure):
      2> if the UE is unable to comply with any part of the configuration included in the RRCReconfiguration message:
         3> perform the actions defined for this failure case as defined in the specifications applicable for the other RAT.
   NOTE 1: The UE may apply above failure handling also in case the RRCReconfiguration message causes a protocol error for which the generic error handling as defined in 10 specifies that the UE shall ignore the message.
   NOTE 2: If the UE is unable to comply with part of the configuration, it does not apply any part of the configuration, i.e. there is no partial success/failure.
   1> else if RRCConditionalReconfiguration (or any other message containing CHO configuration) is received via NR:
      2> if the UE is unable to comply with (part of) the configuration included in the RRCConditionalReconfiguration message;
         3> continue using the configuration used prior to the reception of RRCReconfiguration message;
         3> if security has not been activated:
            4> perform the actions upon going to RRC_IDLE as specified in 5.3.11, with release cause ‘other’
         3> else if AS security has been activated but SRB2 and at least one DRB have not been setup:
            4> perform the actions upon going to RRC_IDLE as specified in 5.3.11, with release cause ‘RRC connection failure’;
         3> if security has been activated and CHO is configured (i.e. UE is monitoring CHO trigger conditions):
            4> perform cell selection and, if selected cell is a cell for which the UE has stored a CHO configuration:
            5> clear the information included in VarRLF-Report, if any;
            5> store the following radio link failure information in the VarRLF-Report by setting its fields as follows:
            6> if the inability to comply occurred for CHO configurations, include in the report an indication of the cell(s) associated to the configuration that was not compliant, the cell identifiers for the cells being monitored, available measurements for the cells being monitored (e.g. RSRP, RSRQ, SINR, etc.) and other information related to CHO;
            5> apply the stored RRCReconfiguration and perform actions as specified in 5.3.5.3 and delete the other stored CHO related configurations;
            4> else, if selected cell is not a cell for which the UE has stored a CHO configuration:
            5> initiate the connection re-establishment procedure as specified in 5.3.7, upon which the reconfiguration procedure ends.

If the UE is not able to comply with the target configuration (the configuration to be used in the target node after the handover), the UE could simply notify the network that for at least one CHO configuration (e.g. one trigger conditions and/or an RRCReconfiguration) the UE was not able to comply. That may be provided in a response message to the CHO configuration e.g. an RRCConditionalReconfigurationComplete.

In another embodiment the UE would in this scenario trigger a reestablishment procedure to reestablish the connection to the network. The UE may during the reestablishment procedure inform the network that the cause of the reestablishment is due to a failure to comply with the CHO configuration. That may for example be implemented by the UE setting the reestablishmentCause field to a certain value. Below it is illustrated how that could be implemented in 3GPP TS 38.331.

### BEGINNING OF EXAMPLE

RRCReestablishmentRequest

The RRCReestablishmentRequest message is used to request the reestablishment of an RRC connection.

Signalling radio bearer: SRBO

RLC-SAP: TM

Logical channel: CCCH

Direction: UE to Network

RRCReestablishmentRequest message

-- ASN1START
-- TAG-RRCREESTABLISHMENTREQUEST-START

| | |
|---|---|
| RRCReestablishmentRequest ::= | SEQUENCE { |

| | |
|---|---|
| rrcReestablishmentRequest | RRCReestablishmentRequest-IEs |

| | |
|---|---|
| } | |
| RRCReestablishmentRequest-IEs ::= | SEQUENCE { |

| | |
|---|---|
| ue-Identity | ReestabUE-Identity, |

| | |
|---|---|
| reestablishmentCause | ReestablishmentCause, |

| | |
|---|---|
| spare | BIT STRING (SIZE (1)) |

}

| | |
|---|---|
| ReestabUE-Identity ::= | SEQUENCE { |

| | |
|---|---|
| c-RNTI | RNTI-Value, |

| | |
|---|---|
| physCellId | PhysCellId, |

| | |
|---|---|
| shortMAC-I | ShortMAC-I |

}

| | |
|---|---|
| ReestablishmentCause ::= | ENUMERATED {reconfigurationFailure, |

handoverFailure, otherFailure, incompatibleCHO}
-- TAG-RRCREESTABLISHMENTREQUEST-STOP
-- ASN1STOP
ReestabUE-Identity field descriptions
physCellId
The Physical Cell Identity of the PCell the UE was connected to prior to the
failure.
RRCReestablishmentRequest-IEs field descriptions
reestablishmentCause
Indicates the failure cause that triggered the re-establishment procedure. gNB is
not expected to reject a RRCReestablishmentRequest due to unknown cause
value being used by the UE.
ue-Identity
UE identity included to retrieve UE context and to facilitate contention resolution
by lower layers.

### END OF EXAMPLE

In case the UE has been configured with multiple targets in the CHO (which may be seen as multiple CHOs) it may be so that the UE only fails to comply with a subset of the CHOs. The UE may in this scenario indicate which CHO(s) that failed. That may be indicated by an index associated with the CHO(s) which has failed, or an identity associated with the target of the failed CHO(s) such as a PCI, etc.

Below is an example of how some of the cases listed above can be implemented in ASN.1.

BEGINNING OF EXAMPLE

| | | |
|---|---|---|
| [[ locationInfo-r10 | LocationInfo-r10 | OPTIONAL, |

| | |
|---|---|
| failedPCellId-r10 | CHOICE { |

| | |
|---|---|
| cellGloballd-r10 | CellGloballdEUTRA, |
| pci-arfcn-r10 | SEQUENCE { |

| | |
|---|---|
| physCellId-r10 | PhysCellId, |
| carrierFreq-r10 | ARFCN-ValueEUTRA |

}

| | } | |
|---|---|---|
| OPTIONAL, | | |
| | reestablishmentCellId-r10 | CellGlobalIdEUTRA |

| OPTIONAL, | | |
|---|---|---|
| | timeConnFailure-r10 | INTEGER (0..1023) |

| OPTIONAL, | | |
|---|---|---|
| | connectionFailureType-r10 | ENUMERATED {rlf, hof} |

| OPTIONAL, | | |
|---|---|---|
| | previousPCellId-r10 | CellGlobalIdEUTRA |

| OPTIONAL | |
|---|---|
| ]], | |
| [[ failedPCellId-v1090 | SEQUENCE { |

| | |
|---|---|
| carrierFreq-v1090 | ARFCN-ValueEUTRA-v9e0 |

}

| OPTIONAL | |
|---|---|
| ]], | |
| [[ basicFields-r11 | SEQUENCE { |

| | |
|---|---|
| c-RNTI-r11 | C-RNTI, |
| rlf-Cause-r11 | ENUMERATED { |

t310-Expiry, randomAccessProblem,
rlc-MaxNumRetx, t312-Expiry-r12},

| | |
|---|---|
| timeSinceFailure-r11 | TimeSinceFailure-r11 |

| | } | |
|---|---|---|
| OPTIONAL, | | |
| | previousUTRA-CellId-r11 | SEQUENCE { |

| | |
|---|---|
| carrierFreq-r11 | ARFCN-ValueUTRA, |
| physCellId-r11 | CHOICE { |

| | |
|---|---|
| fdd-r11 | PhysCellIdUTRA-FDD, |
| tdd-r11 | PhysCellIdUTRA-TDD |

| }, | |
|---|---|
| cellGlobalId-r11 | CellGlobalIdUTRA |

| OPTIONAL | | |
|---|---|---|
| | } | |
| OPTIONAL, | | |
| | selectedUTRA-CellId-r11 | SEQUENCE { |

| | |
|---|---|
| carrierFreq-r11 | ARFCN-ValueUTRA, |
| physCellId-r11 | CHOICE { |

| | |
|---|---|
| fdd-r11 | PhysCellIdUTRA-FDD, |
| tdd-r11 | PhysCellIdUTRA-TDD |

}

}

| OPTIONAL | | | |
|---|---|---|---|
| ]], | | | |
| [[ failedPCellId-v1250 | | SEQUENCE { | |
| | tac-FailedPCell-r12 | | TrackingAreaCode |

| | } | | |
|---|---|---|---|
| OPTIONAL, | | | |
| | measResultLastServCell-v1250 | | RSRQ-Range-v1250 |
| OPTIONAL, | | | |
| | lastServCellRSRQ-Type-r12 | | RSRQ-Type-r12 |
| OPTIONAL, | | | |
| | measResultListEUTRA-v1250 | | MeasResultList2EUTRA-v1250 |
| OPTIONAL | | | |
| ]], | | | |
| [[ drb-EstablishedWithQCI-1-r13 | | ENUMERATED {qci1} | |
| OPTIONAL | | | |
| ]], | | | |
| [[ measResultLastServCell-v1360 | | | RSRP-Range-v1360 |
| OPTIONAL | | | |
| ]], | | | |
| [[ logMeasResultListBT-r15 | | | LogMeasResultListBT-r15 |
| OPTIONAL, | | | |
| | logMeasResultListWLAN-r15 | | LogMeasResultListWLAN-r15 |

| OPTIONAL | | |
|---|---|---|
| ]], | | |
| [[ connectionFailureType-r16 | | ENUMERATED {rlf, hof, chof} |
| OPTIONAL, | | |
| | rlf-Cause-r16 | ENUMERATED { |

t310-Expiry, randomAccessProblem,
rlc-MaxNumRetx, t312-Expiry-r12
t304-Expiry, txxx-Expiry,
incomatibleTargetConfig},

]]

If the UE cannot comply with the target configuration, the target gNB may be informed about the failure. If the UE detects the failure upon handover execution (case A) the gNB in which the UE re-establishes informs the CHO target gNB about the failure to comply with the target configuration by means of network signaling. If the UE detects it upon CHO configuration (case B), source gNB informs the CHO target gNB about the failure to comply with the target configuration by means of network signaling. The failure could e.g. be reported in the message HANDOVER REPORT.

The message contains the RLF report in case RLF was triggered (typically in case A), but needs to be updated with information about inability to comply with target configuration in case the problem was detected already upon CHO configuration (case B). Below is an example update of the X2AP specification 36.423.

### 8.3.10 Handover Report

### 8.3.10.1 General

The purpose of the Handover Report procedure is to transfer mobility related information between eNBs.

The procedure uses non UE-associated signalling.

### 8.3.10.2 Successful Operation

An eNB initiates the procedure by sending an HANDOVER REPORT message to another eNB. By sending the message eNB₁ indicates to eNB₂ that a mobility-related problem was detected.

If the Handover Report Type IE is set to “HO too early” or “HO to wrong cell”, then the eNB₁ indicates to eNB₂ that, following a successful handover from a cell of eNB₂ to a cell of eNB₁, a radio link failure occurred and the UE attempted RRC Re-establishment either at the original cell of eNB₂ (Handover Too Early), or at another cell (Handover to Wrong Cell). The detection of Handover Too Early and Handover to Wrong Cell events is made according to TS 36.300 [15].

If the Handover Report Type IE is set to “CHO configuration failure”, then the eNB₁ indicates to eNB₂ that the UE was not able to comply with the configuration for a conditional handover.

If the UE-related information is available in eNB₁, the eNB₁ should include in HANDOVER REPORT message:
the Mobility Information IE, if the Mobility Information IE was sent for this handover from eNB₂;
the Source cell C-RNTI IE.

If received, the eNB₂ uses the above information according to TS 36.300 [15].

If the UE RLF Report received from the eNB sending the RLF INDICATION message, as described in TS 36.300 [15], is available, the eNBi may also include it in the HANDOVER REPORT as UE RLF Report Container IE and optionally also UE RLF Report Container for extended bands IE.

If the Handover Report Type IE is set to “InterRAT ping-pong”, then the eNB₁ indicates to eNB₂ that a completed handover from a cell of eNB₂ to a cell in other RAT might have resulted in an inter-RAT ping-pong and the UE was successfully handed over to a cell of eNB₁ (indicated with Failure cell ECGI IE).

The report contains the source and target cells, and cause of the handover. If the Handover Report Type IE is set to “HO to wrong cell”, then the Re-establishment cell ECGI IE shall be included in the HANDOVER REPORT message. If the Handover Report Type IE is set to “InterRAT ping-pong”, then the Target cell in UTRAN IE shall be included in the HANDOVER REPORT message.

### Handover Report

This message is sent by the eNB₁ to report a handover failure event or other critical mobility problem.

Direction: eNB₁→eNB₂.

| | | IE type and | |
|---|---|---|---|
| IE/Group Name | Presence | reference | Semantics description |
| Message Type | M | 9.2.13 | |
| Handover Report | M | ENUMERATED | |
| Type | | (HO too early, HO | |
| | | to wrong cell, . . . , | |
| | | InterRAT ping- | |
| | | pong, CHO | |
| | | configuration | |
| | | failure) | |
| Handover Cause | M | Cause | Indicates handover cause |
| | | 9.2.6 | employed for handover from eNB₂ |
| Source cell ECGI | M | ECGI | ECGI of source cell for handover |
| | | 9.2.14 | procedure (in eNB₂) |
| Failure cell ECGI | M | ECGI | ECGI of target cell for handover |
| | | 9.2.14 | procedure (in eNB₁) |
| Re-establishment | C-ifHandover | ECGI | ECGI of cell where UE attempted |
| cell ECGI | ReportType | 9.2.14 | re-establishment |
| | HoToWrongCell | | |
| Target cell in | C-ifHandover | OCTET STRING | Encoded according to UTRAN |
| UTRAN | ReportType | | Cell ID in the Last Visited UTRAN |
| | InterRATpingpong | | Cell Information IE, as defined in |
| | | | in TS 25.413 [24] |
| Source cell C- | O | BIT STRING | C-RNTI allocated at the source |
| RNTI | | (SIZE (16)) | eNB (in eNB₂) contained in the |
| | | | AS-config (TS 36.331 [9]). |
| Mobility | O | BIT STRING | Information provided in the |
| Information | | (SIZE (32)) | HANDOVER REQUEST message |
| | | | from eNB₂. |
| UE RLF Report | O | OCTET STRING | The UE RLF Report Container IE |
| Container | | | received in the RLF INDICATION |
| | | | message. |
| UE RLF Report | O | OCTET STRING | The UE RLF Report Container for |
| Container for | | | extended bands IE received in |
| extended bands | | | the RLF INDICATION message. |

| Condition | Explanation |
|---|---|
| ifHandoverReportType | This IE shall be present if the Handover Report |
| HoToWrongCell | Type IE is set to the value “HO to wrong cell” |
| ifHandoverReportType | This IE shall be present if the Handover Report |
| InterRATpingpong | Type IE is set to the value “InterRAT ping-pong” |

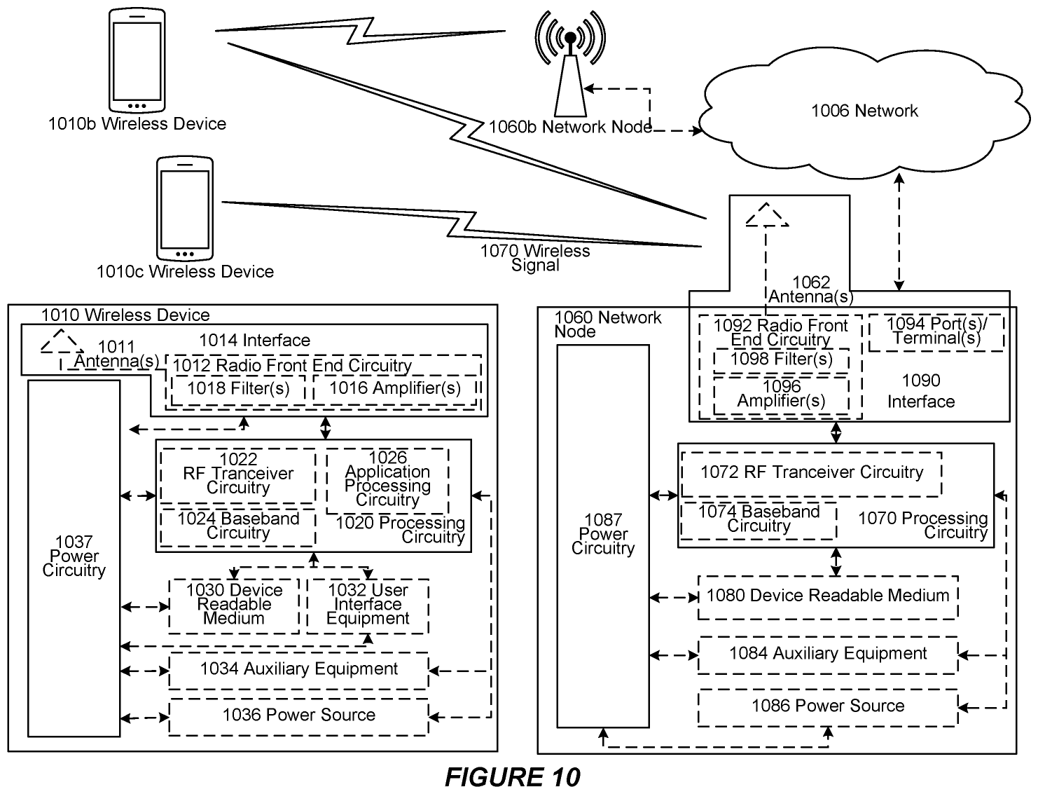

Although the subject matter described herein may be implemented in any appropriate type of system using any suitable components, the embodiments disclosed herein are described in relation to a wireless network, such as the example wireless network illustrated in FIG. 10. For simplicity, the wireless network of FIG. 10 only depicts network 1006, network nodes 1060 and 1060b, and WDs 1010, 1010b, and 1010c. In practice, a wireless network may further include any additional elements suitable to support communication between wireless devices or between a wireless device and another communication device, such as a landline telephone, a service provider, or any other network node or end device. Of the illustrated components, network node 1060 and wireless device (WD) 1010 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), Narrowband Internet of Things (NB-IoT), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1006 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1060 and WD 1010 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MM Es), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 10, network node 1060 includes processing circuitry 1070, device readable medium 1080, interface 1090, auxiliary equipment 1084, power source 1086, power circuitry 1087, and antenna 1062. Although network node 1060 illustrated in the example wireless network of FIG. 10 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 1060 are depicted as single boxes located within a larger box, or nested within multiple boxes, in practice, a network node may comprise multiple different physical components that make up a single illustrated component (e.g., device readable medium 1080 may comprise multiple separate hard drives as well as multiple RAM modules).

Similarly, network node 1060 may be composed of multiple physically separate components (e.g., a NodeB component and a RNC component, or a BTS component and a BSC component, etc.), which may each have their own respective components. In certain scenarios in which network node 1060 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 1060 may be configured to support multiple radio access technologies (RATs). In such embodiments, some components may be duplicated (e.g., separate device readable medium 1080 for the different RATs) and some components may be reused (e.g., the same antenna 1062 may be shared by the RATs). Network node 1060 may also include multiple sets of the various illustrated components for different wireless technologies integrated into network node 1060, such as, for example, GSM, WCDMA, LTE, NR, WiFi, or Bluetooth wireless technologies. These wireless technologies may be integrated into the same or different chip or set of chips and other components within network node 1060.

Processing circuitry 1070 is configured to perform any determining, calculating, or similar operations (e.g., certain obtaining operations) described herein as being provided by a network node. These operations performed by processing circuitry 1070 may include processing information obtained by processing circuitry 1070 by, for example, converting the obtained information into other information, comparing the obtained information or converted information to information stored in the network node, and/or performing one or more operations based on the obtained information or converted information, and as a result of said processing making a determination.

Processing circuitry 1070 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1060 components, such as device readable medium 1080, network node 1060 functionality. For example, processing circuitry 1070 may execute instructions stored in device readable medium 1080 or in memory within processing circuitry 1070. Such functionality may include providing any of the various wireless features, functions, or benefits discussed herein. In some embodiments, processing circuitry 1070 may include a system on a chip (SOC).

In some embodiments, processing circuitry 1070 may include one or more of radio frequency (RF) transceiver circuitry 1072 and baseband processing circuitry 1074. In some embodiments, radio frequency (RF) transceiver circuitry 1072 and baseband processing circuitry 1074 may be on separate chips (or sets of chips), boards, or units, such as radio units and digital units. In alternative embodiments, part or all of RF transceiver circuitry 1072 and baseband processing circuitry 1074 may be on the same chip or set of chips, boards, or units

In certain embodiments, some or all of the functionality described herein as being provided by a network node, base station, eNB or other such network device may be performed by processing circuitry 1070 executing instructions stored on device readable medium 1080 or memory within processing circuitry 1070. In alternative embodiments, some or all of the functionality may be provided by processing circuitry 1070 without executing instructions stored on a separate or discrete device readable medium, such as in a hard-wired manner. In any of those embodiments, whether executing instructions stored on a device readable storage medium or not, processing circuitry 1070 can be configured to perform the described functionality. The benefits provided by such functionality are not limited to processing circuitry 1070 alone or to other components of network node 1060, but are enjoyed by network node 1060 as a whole, and/or by end users and the wireless network generally.

Device readable medium 1080 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1070. Device readable medium 1080 may store any suitable instructions, data or information, including a computer program, software, an application including one or more of logic, rules, code, tables, etc. and/or other instructions capable of being executed by processing circuitry 1070 and, utilized by network node 1060. Device readable medium 1080 may be used to store any calculations made by processing circuitry 1070 and/or any data received via interface 1090. In some embodiments, processing circuitry 1070 and device readable medium 1080 may be considered to be integrated.

Interface 1090 is used in the wired or wireless communication of signalling and/or data between network node 1060, network 1006, and/or WDs 1010. As illustrated, interface 1090 comprises port(s)/terminal(s) 1094 to send and receive data, for example to and from network 1006 over a wired connection. Interface 1090 also includes radio front end circuitry 1092 that may be coupled to, or in certain embodiments a part of, antenna 1062. Radio front end circuitry 1092 comprises filters 1098 and amplifiers 1096. Radio front end circuitry 1092 may be connected to antenna 1062 and processing circuitry 1070. Radio front end circuitry may be configured to condition signals communicated between antenna 1062 and processing circuitry 1070. Radio front end circuitry 1092 may receive digital data that is to be sent out to other network nodes or WDs via a wireless connection. Radio front end circuitry 1092 may convert the digital data into a radio signal having the appropriate channel and bandwidth parameters using a combination of filters 1098 and/or amplifiers 1096. The radio signal may then be transmitted via antenna 1062. Similarly, when receiving data, antenna 1062 may collect radio signals which are then converted into digital data by radio front end circuitry 1092. The digital data may be passed to processing circuitry 1070. In other embodiments, the interface may comprise different components and/or different combinations of components.

In certain alternative embodiments, network node 1060 may not include separate radio front end circuitry 1092, instead, processing circuitry 1070 may comprise radio front end circuitry and may be connected to antenna 1062 without separate radio front end circuitry 1092. Similarly, in some embodiments, all or some of RF transceiver circuitry 1072 may be considered a part of interface 1090. In still other embodiments, interface 1090 may include one or more ports or terminals 1094, radio front end circuitry 1092, and RF transceiver circuitry 1072, as part of a radio unit (not shown), and interface 1090 may communicate with baseband processing circuitry 1074, which is part of a digital unit (not shown).

Antenna 1062 may include one or more antennas, or antenna arrays, configured to send and/or receive wireless signals. Antenna 1062 may be coupled to radio front end circuitry 1090 and may be any type of antenna capable of transmitting and receiving data and/or signals wirelessly. In some embodiments, antenna 1062 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1062 may be separate from network node 1060 and may be connectable to network node 1060 through an interface or port.

Antenna 1062, interface 1090, and/or processing circuitry 1070 may be configured to perform any receiving operations and/or certain obtaining operations described herein as being performed by a network node. Any information, data and/or signals may be received from a wireless device, another network node and/or any other network equipment. Similarly, antenna 1062, interface 1090, and/or processing circuitry 1070 may be configured to perform any transmitting operations described herein as being performed by a network node. Any information, data and/or signals may be transmitted to a wireless device, another network node and/or any other network equipment.

Power circuitry 1087 may comprise, or be coupled to, power management circuitry and is configured to supply the components of network node 1060 with power for performing the functionality described herein. Power circuitry 1087 may receive power from power source 1086. Power source 1086 and/or power circuitry 1087 may be configured to provide power to the various components of network node 1060 in a form suitable for the respective components (e.g., at a voltage and current level needed for each respective component). Power source 1086 may either be included in, or external to, power circuitry 1087 and/or network node 1060. For example, network node 1060 may be connectable to an external power source (e.g., an electricity outlet) via an input circuitry or interface such as an electrical cable, whereby the external power source supplies power to power circuitry 1087. As a further example, power source 1086 may comprise a source of power in the form of a battery or battery pack which is connected to, or integrated in, power circuitry 1087. The battery may provide backup power should the external power source fail. Other types of power sources, such as photovoltaic devices, may also be used.

Alternative embodiments of network node 1060 may include additional components beyond those shown in FIG. 10 that may be responsible for providing certain aspects of the network node's functionality, including any of the functionality described herein and/or any functionality necessary to support the subject matter described herein. For example, network node 1060 may include user interface equipment to allow input of information into network node 1060 and to allow output of information from network node 1060. This may allow a user to perform diagnostic, maintenance, repair, and other administrative functions for network node 1060.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 1010 includes antenna 1011, interface 1014, processing circuitry 1020, device readable medium 1030, user interface equipment 1032, auxiliary equipment 1034, power source 1036 and power circuitry 1037. WD 1010 may include multiple sets of one or more of the illustrated components for different wireless technologies supported by WD 1010, such as, for example, GSM, WCDMA, LTE, NR, WiFi, WiMAX, NB-IoT, or Bluetooth wireless technologies, just to mention a few. These wireless technologies may be integrated into the same or different chips or set of chips as other components within WD 1010.

Antenna 1011 may include one or more antennas or antenna arrays, configured to send and/or receive wireless signals, and is connected to interface 1014. In certain alternative embodiments, antenna 1011 may be separate from WD 1010 and be connectable to WD 1010 through an interface or port. Antenna 1011, interface 1014, and/or processing circuitry 1020 may be configured to perform any receiving or transmitting operations described herein as being performed by a WD. Any information, data and/or signals may be received from a network node and/or another WD. In some embodiments, radio front end circuitry and/or antenna 1011 may be considered an interface.

As illustrated, interface 1014 comprises radio front end circuitry 1012 and antenna 1011. Radio front end circuitry 1012 comprise one or more filters 1018 and amplifiers 1016. Radio front end circuitry 1014 is connected to antenna 1011 and processing circuitry 1020, and is configured to condition signals communicated between antenna 1011 and processing circuitry 1020. Radio front end circuitry 1012 may be coupled to or a part of antenna 1011. In some embodiments, WD 1010 may not include separate radio front end circuitry 1012; rather, processing circuitry 1020 may comprise radio front end circuitry and may be connected to antenna 1011. Similarly, in some embodiments, some or all of RF transceiver circuitry 1022 may be considered a part of interface 1014. Radio front end circuitry 1012 may receive digital data that is to be sent out to other network nodes or WDs via a wireless connection. Radio front end circuitry 1012 may convert the digital data into a radio signal having the appropriate channel and bandwidth parameters using a combination of filters 1018 and/or amplifiers 1016. The radio signal may then be transmitted via antenna 1011. Similarly, when receiving data, antenna 1011 may collect radio signals which are then converted into digital data by radio front end circuitry 1012. The digital data may be passed to processing circuitry 1020. In other embodiments, the interface may comprise different components and/or different combinations of components.

Processing circuitry 1020 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1010 components, such as device readable medium 1030, WD 1010 functionality. Such functionality may include providing any of the various wireless features or benefits discussed herein. For example, processing circuitry 1020 may execute instructions stored in device readable medium 1030 or in memory within processing circuitry 1020 to provide the functionality disclosed herein.

As illustrated, processing circuitry 1020 includes one or more of RF transceiver circuitry 1022, baseband processing circuitry 1024, and application processing circuitry 1026. In other embodiments, the processing circuitry may comprise different components and/or different combinations of components. In certain embodiments processing circuitry 1020 of WD 1010 may comprise a SOC. In some embodiments, RF transceiver circuitry 1022, baseband processing circuitry 1024, and application processing circuitry 1026 may be on separate chips or sets of chips. In alternative embodiments, part or all of baseband processing circuitry 1024 and application processing circuitry 1026 may be combined into one chip or set of chips, and RF transceiver circuitry 1022 may be on a separate chip or set of chips. In still alternative embodiments, part or all of RF transceiver circuitry 1022 and baseband processing circuitry 1024 may be on the same chip or set of chips, and application processing circuitry 1026 may be on a separate chip or set of chips. In yet other alternative embodiments, part or all of RF transceiver circuitry 1022, baseband processing circuitry 1024, and application processing circuitry 1026 may be combined in the same chip or set of chips. In some embodiments, RF transceiver circuitry 1022 may be a part of interface 1014. RF transceiver circuitry 1022 may condition RF signals for processing circuitry 1020.

In certain embodiments, some or all of the functionality described herein as being performed by a WD may be provided by processing circuitry 1020 executing instructions stored on device readable medium 1030, which in certain embodiments may be a computer-readable storage medium. In alternative embodiments, some or all of the functionality may be provided by processing circuitry 1020 without executing instructions stored on a separate or discrete device readable storage medium, such as in a hard-wired manner. In any of those particular embodiments, whether executing instructions stored on a device readable storage medium or not, processing circuitry 1020 can be configured to perform the described functionality. The benefits provided by such functionality are not limited to processing circuitry 1020 alone or to other components of WD 1010, but are enjoyed by WD 1010 as a whole, and/or by end users and the wireless network generally.

Processing circuitry 1020 may be configured to perform any determining, calculating, or similar operations (e.g., certain obtaining operations) described herein as being performed by a WD. These operations, as performed by processing circuitry 1020, may include processing information obtained by processing circuitry 1020 by, for example, converting the obtained information into other information, comparing the obtained information or converted information to information stored by WD 1010, and/or performing one or more operations based on the obtained information or converted information, and as a result of said processing making a determination.

Device readable medium 1030 may be operable to store a computer program, software, an application including one or more of logic, rules, code, tables, etc. and/or other instructions capable of being executed by processing circuitry 1020. Device readable medium 1030 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1020. In some embodiments, processing circuitry 1020 and device readable medium 1030 may be considered to be integrated.

User interface equipment 1032 may provide components that allow for a human user to interact with WD 1010. Such interaction may be of many forms, such as visual, audial, tactile, etc. User interface equipment 1032 may be operable to produce output to the user and to allow the user to provide input to WD 1010. The type of interaction may vary depending on the type of user interface equipment 1032 installed in WD 1010. For example, if WD 1010 is a smart phone, the interaction may be via a touch screen; if WD 1010 is a smart meter, the interaction may be through a screen that provides usage (e.g., the number of gallons used) or a speaker that provides an audible alert (e.g., if smoke is detected). User interface equipment 1032 may include input interfaces, devices and circuits, and output interfaces, devices and circuits. User interface equipment 1032 is configured to allow input of information into WD 1010, and is connected to processing circuitry 1020 to allow processing circuitry 1020 to process the input information. User interface equipment 1032 may include, for example, a microphone, a proximity or other sensor, keys/buttons, a touch display, one or more cameras, a USB port, or other input circuitry. User interface equipment 1032 is also configured to allow output of information from WD 1010, and to allow processing circuitry 1020 to output information from WD 1010. User interface equipment 1032 may include, for example, a speaker, a display, vibrating circuitry, a USB port, a headphone interface, or other output circuitry. Using one or more input and output interfaces, devices, and circuits, of user interface equipment 1032, WD 1010 may communicate with end users and/or the wireless network, and allow them to benefit from the functionality described herein.

Auxiliary equipment 1034 is operable to provide more specific functionality which may not be generally performed by WDs. This may comprise specialized sensors for doing measurements for various purposes, interfaces for additional types of communication such as wired communications etc. The inclusion and type of components of auxiliary equipment 1034 may vary depending on the embodiment and/or scenario.

Power source 1036 may, in some embodiments, be in the form of a battery or battery pack. Other types of power sources, such as an external power source (e.g., an electricity outlet), photovoltaic devices or power cells, may also be used. WD 1010 may further comprise power circuitry 1037 for delivering power from power source 1036 to the various parts of WD 1010 which need power from power source 1036 to carry out any functionality described or indicated herein. Power circuitry 1037 may in certain embodiments comprise power management circuitry. Power circuitry 1037 may additionally or alternatively be operable to receive power from an external power source; in which case WD 1010 may be connectable to the external power source (such as an electricity outlet) via input circuitry or an interface such as an electrical power cable. Power circuitry 1037 may also in certain embodiments be operable to deliver power from an external power source to power source 1036. This may be, for example, for the charging of power source 1036. Power circuitry 1037 may perform any formatting, converting, or other modification to the power from power source 1036 to make the power suitable for the respective components of WD 1010 to which power is supplied.

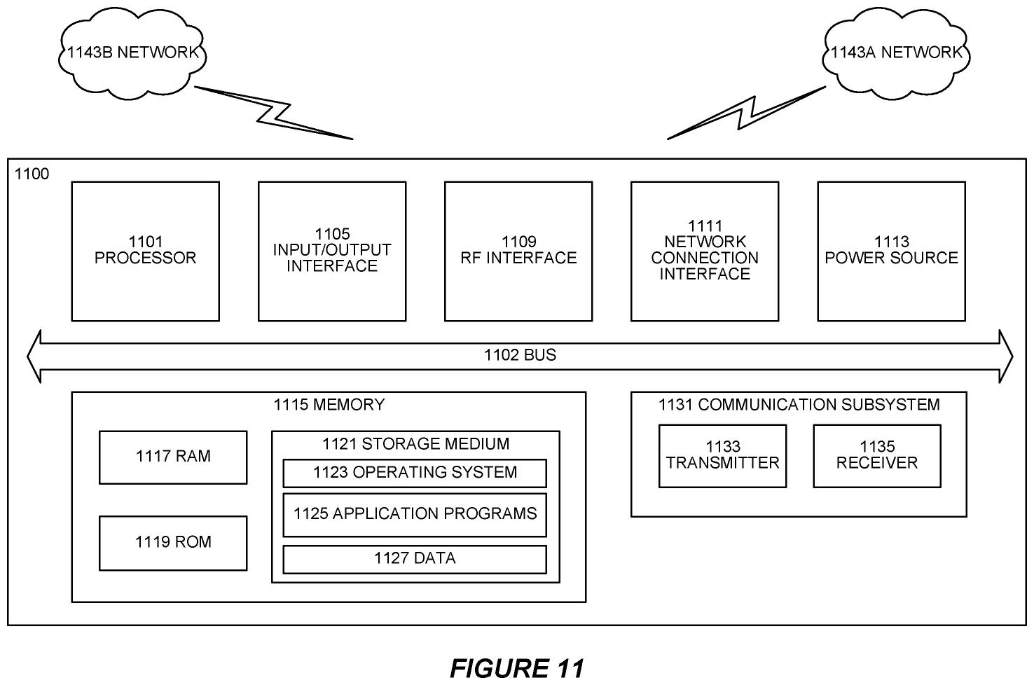

FIG. 11 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 11200 may be any UE identified by the 3^{rd} Generation Partnership Project (3GPP), including a NB-IoT UE, a machine type communication (MTC) UE, and/or an enhanced MTC (eMTC) UE. UE 1100, as illustrated in FIG. 11, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 11 is a UE, the components discussed herein are equally applicable to a WD, and vice-versa.

In FIG. 11, UE 1100 includes processing circuitry 1101 that is operatively coupled to input/output interface 1105, radio frequency (RF) interface 1109, network connection interface 1111, memory 1115 including random access memory (RAM) 1117, read-only memory (ROM) 1119, and storage medium 1121 or the like, communication subsystem 1131, power source 1133, and/or any other component, or any combination thereof. Storage medium 1121 includes operating system 1123, application program 1125, and data 1127. In other embodiments, storage medium 1121 may include other similar types of information. Certain UEs may utilize all of the components shown in FIG. 11, or only a subset of the components. The level of integration between the components may vary from one UE to another UE. Further, certain UEs may contain multiple instances of a component, such as multiple processors, memories, transceivers, transmitters, receivers, etc.

In FIG. 11, processing circuitry 1101 may be configured to process computer instructions and data. Processing circuitry 1101 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1101 may include two central processing units (CPUs). Data may be information in a form suitable for use by a computer.

In the depicted embodiment, input/output interface 1105 may be configured to provide a communication interface to an input device, output device, or input and output device. UE 1100 may be configured to use an output device via input/output interface 1105. An output device may use the same type of interface port as an input device. For example, a USB port may be used to provide input to and output from UE 1100. The output device may be a speaker, a sound card, a video card, a display, a monitor, a printer, an actuator, an emitter, a smartcard, another output device, or any combination thereof. UE 1100 may be configured to use an input device via input/output interface 1105 to allow a user to capture information into UE 1100. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 11, RF interface 1109 may be configured to provide a communication interface to RF components such as a transmitter, a receiver, and an antenna. Network connection interface 1111 may be configured to provide a communication interface to network 1143a. Network 1143a may encompass wired and/or wireless networks such as a local-area network (LAN), a wide-area network (WAN), a computer network, a wireless network, a telecommunications network, another like network or any combination thereof. For example, network 1143a may comprise a Wi-Fi network. Network connection interface 1111 may be configured to include a receiver and a transmitter interface used to communicate with one or more other devices over a communication network according to one or more communication protocols, such as Ethernet, TCP/IP, SONET, ATM, or the like. Network connection interface 1111 may implement receiver and transmitter functionality appropriate to the communication network links (e.g., optical, electrical, and the like). The transmitter and receiver functions may share circuit components, software or firmware, or alternatively may be implemented separately.

RAM 1117 may be configured to interface via bus 1102 to processing circuitry 1101 to provide storage or caching of data or computer instructions during the execution of software programs such as the operating system, application programs, and device drivers. ROM 1119 may be configured to provide computer instructions or data to processing circuitry 1101. For example, ROM 1119 may be configured to store invariant low-level system code or data for basic system functions such as basic input and output (I/O), startup, or reception of keystrokes from a keyboard that are stored in a non-volatile memory. Storage medium 1121 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1121 may be configured to include operating system 1123, application program 1125 such as a web browser application, a widget or gadget engine or another application, and data file 1127. Storage medium 1121 may store, for use by UE 1100, any of a variety of various operating systems or combinations of operating systems.

Storage medium 1121 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1121 may allow UE 1100 to access computer-executable instructions, application programs or the like, stored on transitory or non-transitory memory media, to off-load data, or to upload data. An article of manufacture, such as one utilizing a communication system may be tangibly embodied in storage medium 1121, which may comprise a device readable medium.

In FIG. 11, processing circuitry 1101 may be configured to communicate with network 1143b using communication subsystem 1131. Network 1143a and network 1143b may be the same network or networks or different network or networks. Communication subsystem 1131 may be configured to include one or more transceivers used to communicate with network 1143b. For example, communication subsystem 1131 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 1133 and/or receiver 1135 to implement transmitter or receiver functionality, respectively, appropriate to the RAN links (e.g., frequency allocations and the like). Further, transmitter 1133 and receiver 1135 of each transceiver may share circuit components, software or firmware, or alternatively may be implemented separately.

In the illustrated embodiment, the communication functions of communication subsystem 1131 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1131 may include cellular communication, Wi-Fi communication, Bluetooth communication, and GPS communication. Network 1143b may encompass wired and/or wireless networks such as a local-area network (LAN), a wide-area network (WAN), a computer network, a wireless network, a telecommunications network, another like network or any combination thereof. For example, network 1143b may be a cellular network, a Wi-Fi network, and/or a near-field network. Power source 1113 may be configured to provide alternating current (AC) or direct current (DC) power to components of UE 1100.

The features, benefits and/or functions described herein may be implemented in one of the components of UE 1100 or partitioned across multiple components of UE 1100. Further, the features, benefits, and/or functions described herein may be implemented in any combination of hardware, software or firmware. In one example, communication subsystem 1131 may be configured to include any of the components described herein. Further, processing circuitry 1101 may be configured to communicate with any of such components over bus 1102. In another example, any of such components may be represented by program instructions stored in memory that when executed by processing circuitry 1101 perform the corresponding functions described herein. In another example, the functionality of any of such components may be partitioned between processing circuitry 1101 and communication subsystem 1131. In another example, the non-computationally intensive functions of any of such components may be implemented in software or firmware and the computationally intensive functions may be implemented in hardware.

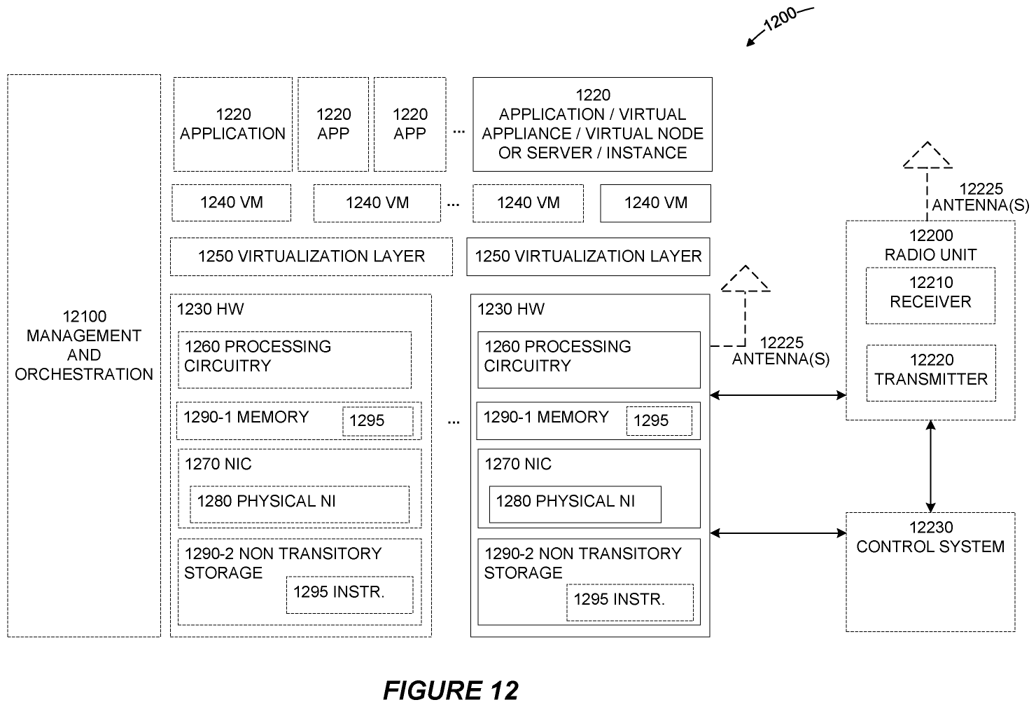

FIG. 12 is a schematic block diagram illustrating a virtualization environment 1200 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1200 hosted by one or more of hardware nodes 1230. Further, in embodiments in which the virtual node is not a radio access node or does not require radio connectivity (e.g., a core network node), then the network node may be entirely virtualized.

The functions may be implemented by one or more applications 1220 (which may alternatively be called software instances, virtual appliances, network functions, virtual nodes, virtual network functions, etc.) operative to implement some of the features, functions, and/or benefits of some of the embodiments disclosed herein. Applications 1220 are run in virtualization environment 1200 which provides hardware 1230 comprising processing circuitry 1260 and memory 1290. Memory 1290 contains instructions 1295 executable by processing circuitry 1260 whereby application 1220 is operative to provide one or more of the features, benefits, and/or functions disclosed herein.

Virtualization environment 1200, comprises general-purpose or special-purpose network hardware devices 1230 comprising a set of one or more processors or processing circuitry 1260, which may be commercial off-the-shelf (COTS) processors, dedicated Application Specific Integrated Circuits (ASICs), or any other type of processing circuitry including digital or analog hardware components or special purpose processors. Each hardware device may comprise memory 1290-1 which may be non-persistent memory for temporarily storing instructions 1295 or software executed by processing circuitry 1260. Each hardware device may comprise one or more network interface controllers (NICs) 1270, also known as network interface cards, which include physical network interface 1280. Each hardware device may also include non-transitory, persistent, machine-readable storage media 1290-2 having stored therein software 1295 and/or instructions executable by processing circuitry 1260. Software 1295 may include any type of software including software for instantiating one or more virtualization layers 1250 (also referred to as hypervisors), software to execute virtual machines 1240 as well as software allowing it to execute functions, features and/or benefits described in relation with some embodiments described herein.

Virtual machines 1240, comprise virtual processing, virtual memory, virtual networking or interface and virtual storage, and may be run by a corresponding virtualization layer 1250 or hypervisor. Different embodiments of the instance of virtual appliance 1220 may be implemented on one or more of virtual machines 1240, and the implementations may be made in different ways.

During operation, processing circuitry 1260 executes software 1295 to instantiate the hypervisor or virtualization layer 1250, which may sometimes be referred to as a virtual machine monitor (VMM). Virtualization layer 1250 may present a virtual operating platform that appears like networking hardware to virtual machine 1240.

As shown in FIG. 12, hardware 1230 may be a standalone network node with generic or specific components. Hardware 1230 may comprise antenna 12225 and may implement some functions via virtualization. Alternatively, hardware 1230 may be part of a larger cluster of hardware (e.g. such as in a data center or customer premise equipment (CPE)) where many hardware nodes work together and are managed via management and orchestration (MANO) 12100, which, among others, oversees lifecycle management of applications 1220.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1240 may be a software implementation of a physical machine that runs programs as if they were executing on a physical, non-virtualized machine. Each of virtual machines 1240, and that part of hardware 1230 that executes that virtual machine, be it hardware dedicated to that virtual machine and/or hardware shared by that virtual machine with others of the virtual machines 1240, forms a separate virtual network elements (VNE).

Still in the context of NFV, Virtual Network Function (VNF) is responsible for handling specific network functions that run in one or more virtual machines 1240 on top of hardware networking infrastructure 1230 and corresponds to application 1220 in FIG. 12.

In some embodiments, one or more radio units 12200 that each include one or more transmitters 12220 and one or more receivers 12210 may be coupled to one or more antennas 12225. Radio units 12200 may communicate directly with hardware nodes 1230 via one or more appropriate network interfaces and may be used in combination with the virtual components to provide a virtual node with radio capabilities, such as a radio access node or a base station.

In some embodiments, some signalling can be effected with the use of control system 12230 which may alternatively be used for communication between the hardware nodes 1230 and radio units 12200.

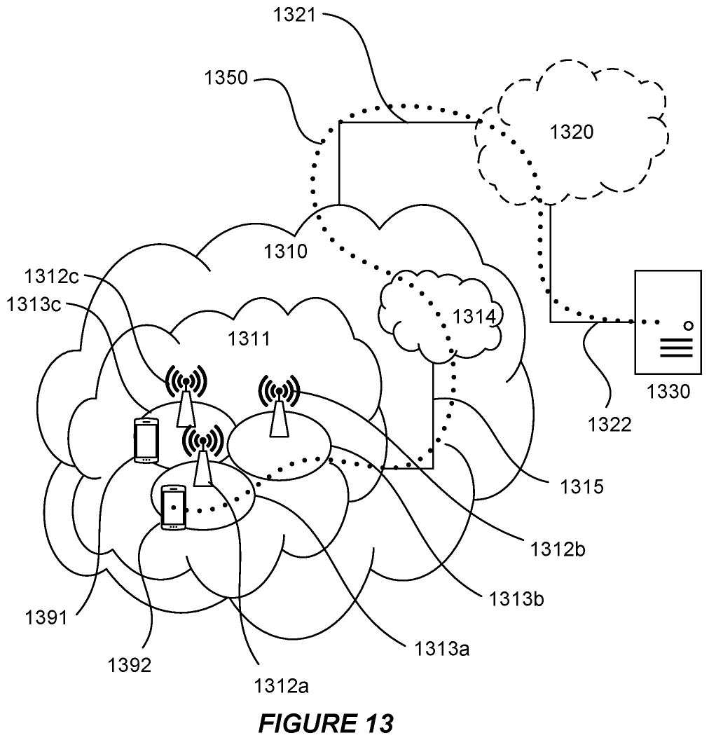

FIG. 13 illustrates a telecommunication network connected via an intermediate network to a host computer in accordance with some embodiments. In particular, with reference to FIG. 13, in accordance with an embodiment, a communication system includes telecommunication network 1310, such as a 3GPP-type cellular network, which comprises access network 1311, such as a radio access network, and core network 1314. Access network 1311 comprises a plurality of base stations 1312a, 1312b, 1312c, such as NBs, eNBs, gNBs or other types of wireless access points, each defining a corresponding coverage area 1313a, 1313b, 1313c. Each base station 1312a, 1312b, 1312c is connectable to core network 1314 over a wired or wireless connection 1315. A first UE 1391 located in coverage area 1313c is configured to wirelessly connect to, or be paged by, the corresponding base station 1312c. A second UE 1392 in coverage area 1313a is wirelessly connectable to the corresponding base station 1312a. While a plurality of UEs 1391, 1392 are illustrated in this example, the disclosed embodiments are equally applicable to a situation where a sole UE is in the coverage area or where a sole UE is connecting to the corresponding base station 1312.

Telecommunication network 1310 is itself connected to host computer 1330, which may be embodied in the hardware and/or software of a standalone server, a cloud-implemented server, a distributed server or as processing resources in a server farm. Host computer 1330 may be under the ownership or control of a service provider, or may be operated by the service provider or on behalf of the service provider. Connections 1321 and 1322 between telecommunication network 1310 and host computer 1330 may extend directly from core network 1314 to host computer 1330 or may go via an optional intermediate network 1320. Intermediate network 1320 may be one of, or a combination of more than one of, a public, private or hosted network; intermediate network 1320, if any, may be a backbone network or the Internet; in particular, intermediate network 1320 may comprise two or more sub-networks (not shown).

The communication system of FIG. 13 as a whole enables connectivity between the connected UEs 1391, 1392 and host computer 1330. The connectivity may be described as an over-the-top (OTT) connection 1350. Host computer 1330 and the connected UEs 1391, 1392 are configured to communicate data and/or signaling via OTT connection 1350, using access network 1311, core network 1314, any intermediate network 1320 and possible further infrastructure (not shown) as intermediaries. OTT connection 1350 may be transparent in the sense that the participating communication devices through which OTT connection 1350 passes are unaware of routing of uplink and downlink communications. For example, base station 1312 may not or need not be informed about the past routing of an incoming downlink communication with data originating from host computer 1330 to be forwarded (e.g., handed over) to a connected UE 1391. Similarly, base station 1312 need not be aware of the future routing of an outgoing uplink communication originating from the UE 1391 towards the host computer 1330.

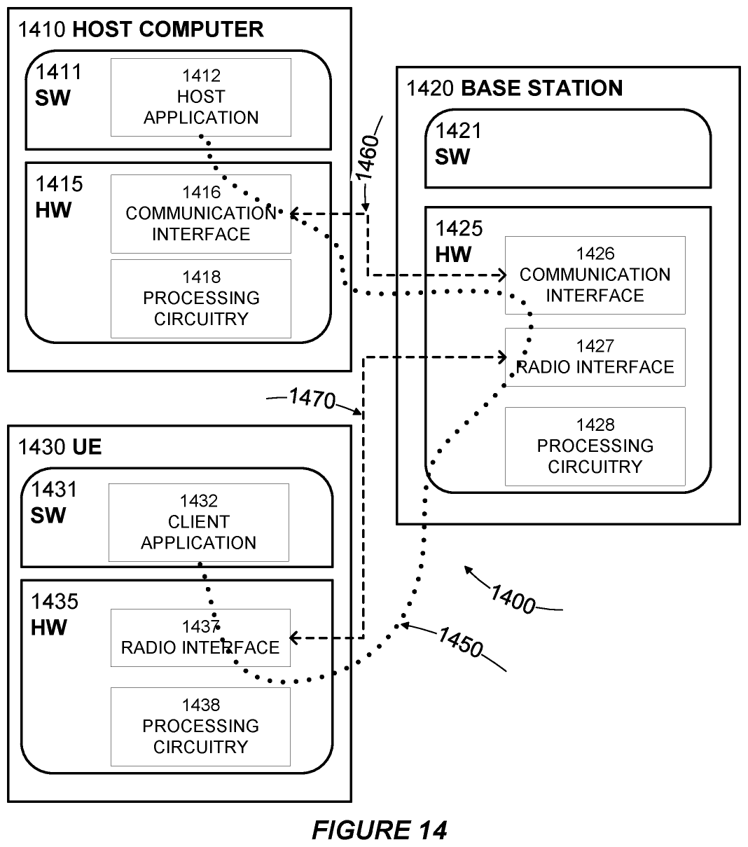

Example implementations, in accordance with an embodiment, of the UE, base station and host computer discussed in the preceding paragraphs will now be described with reference to FIG. 14. FIG. 14 illustrates host computer communicating via a base station with a user equipment over a partially wireless connection in accordance with some embodiments In communication system 1400, host computer 1410 comprises hardware 1415 including communication interface 1416 configured to set up and maintain a wired or wireless connection with an interface of a different communication device of communication system 1400. Host computer 1410 further comprises processing circuitry 1418, which may have storage and/or processing capabilities. In particular, processing circuitry 1418 may comprise one or more programmable processors, application-specific integrated circuits, field programmable gate arrays or combinations of these (not shown) adapted to execute instructions. Host computer 1410 further comprises software 1411, which is stored in or accessible by host computer 1410 and executable by processing circuitry 1418. Software 1411 includes host application 1412. Host application 1412 may be operable to provide a service to a remote user, such as UE 1430 connecting via OTT connection 1450 terminating at UE 1430 and host computer 1410. In providing the service to the remote user, host application 1412 may provide user data which is transmitted using OTT connection 1450.

Communication system 1400 further includes base station 1420 provided in a telecommunication system and comprising hardware 1425 enabling it to communicate with host computer 1410 and with UE 1430. Hardware 1425 may include communication interface 1426 for setting up and maintaining a wired or wireless connection with an interface of a different communication device of communication system 1400, as well as radio interface 1427 for setting up and maintaining at least wireless connection 1470 with UE 1430 located in a coverage area (not shown in FIG. 14) served by base station 1420. Communication interface 1426 may be configured to facilitate connection 1460 to host computer 1410. Connection 1460 may be direct or it may pass through a core network (not shown in FIG. 14) of the telecommunication system and/or through one or more intermediate networks outside the telecommunication system. In the embodiment shown, hardware 1425 of base station 1420 further includes processing circuitry 1428, which may comprise one or more programmable processors, application-specific integrated circuits, field programmable gate arrays or combinations of these (not shown) adapted to execute instructions. Base station 1420 further has software 1421 stored internally or accessible via an external connection.

Communication system 1400 further includes UE 1430 already referred to. Its hardware 1435 may include radio interface 1437 configured to set up and maintain wireless connection 1470 with a base station serving a coverage area in which UE 1430 is currently located. Hardware 1435 of UE 1430 further includes processing circuitry 1438, which may comprise one or more programmable processors, application-specific integrated circuits, field programmable gate arrays or combinations of these (not shown) adapted to execute instructions. UE 1430 further comprises software 1431, which is stored in or accessible by UE 1430 and executable by processing circuitry 1438. Software 1431 includes client application 1432. Client application 1432 may be operable to provide a service to a human or non-human user via UE 1430, with the support of host computer 1410. In host computer 1410, an executing host application 1412 may communicate with the executing client application 1432 via OTT connection 1450 terminating at UE 1430 and host computer 1410. In providing the service to the user, client application 1432 may receive request data from host application 1412 and provide user data in response to the request data. OTT connection 1450 may transfer both the request data and the user data. Client application 1432 may interact with the user to generate the user data that it provides.

It is noted that host computer 1410, base station 1420 and UE 1430 illustrated in FIG. 14 may be similar or identical to host computer 1330, one of base stations 1312a, 1312b, 1312c and one of U Es 1391, 1392 of FIG. 13, respectively. This is to say, the inner workings of these entities may be as shown in FIG. 14 and independently, the surrounding network topology may be that of FIG. 13.

In FIG. 14, OTT connection 1450 has been drawn abstractly to illustrate the communication between host computer 1410 and UE 1430 via base station 1420, without explicit reference to any intermediary devices and the precise routing of messages via these devices. Network infrastructure may determine the routing, which it may be configured to hide from UE 1430 or from the service provider operating host computer 1410, or both. While OTT connection 1450 is active, the network infrastructure may further take decisions by which it dynamically changes the routing (e.g., on the basis of load balancing consideration or reconfiguration of the network).

Wireless connection 1470 between UE 1430 and base station 1420 is in accordance with the teachings of the embodiments described throughout this disclosure. One or more of the various embodiments improve the performance of OTT services provided to UE 1430 using OTT connection 1450, in which wireless connection 1470 forms the last segment. More precisely, the teachings of these embodiments may improve mobility robustness and success rates so as to in turn improve latency, data rate, and device power consumption, and thereby provide benefits such as reduced user waiting time and extended battery lifetime.

A measurement procedure may be provided for the purpose of monitoring data rate, latency and other factors on which the one or more embodiments improve. There may further be an optional network functionality for reconfiguring OTT connection 1450 between host computer 1410 and UE 1430, in response to variations in the measurement results. The measurement procedure and/or the network functionality for reconfiguring OTT connection 1450 may be implemented in software 1411 and hardware 1415 of host computer 1410 or in software 1431 and hardware 1435 of UE 1430, or both. In embodiments, sensors (not shown) may be deployed in or in association with communication devices through which OTT connection 1450 passes; the sensors may participate in the measurement procedure by supplying values of the monitored quantities exemplified above, or supplying values of other physical quantities from which software 1411, 1431 may compute or estimate the monitored quantities. The reconfiguring of OTT connection 1450 may include message format, retransmission settings, preferred routing etc.; the reconfiguring need not affect base station 1420, and it may be unknown or imperceptible to base station 1420. Such procedures and functionalities may be known and practiced in the art. In certain embodiments, measurements may involve proprietary UE signaling facilitating host computer 1410′s measurements of throughput, propagation times, latency and the like. The measurements may be implemented in that software 1411 and 1431 causes messages to be transmitted, in particular empty or ‘dummy’ messages, using OTT connection 1450 while it monitors propagation times, errors etc.

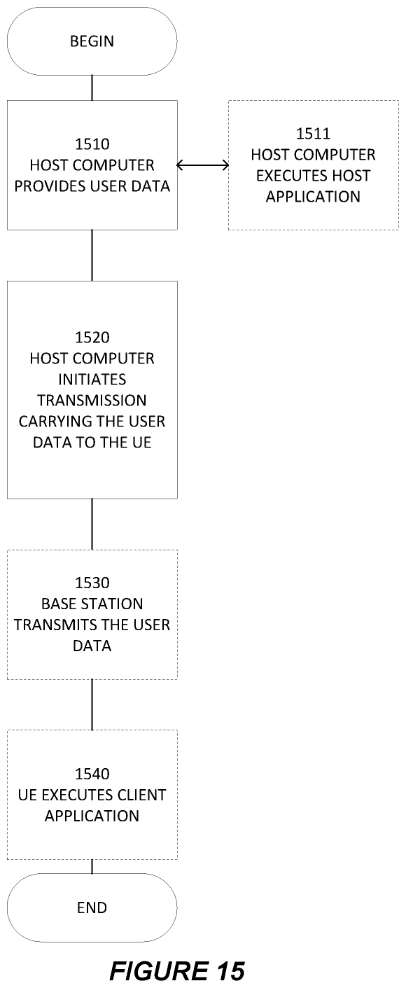

FIG. 15 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 15 will be included in this section. In step 1510, the host computer provides user data. In substep 1511 (which may be optional) of step 1510, the host computer provides the user data by executing a host application. In step 1520, the host computer initiates a transmission carrying the user data to the UE. In step 1530 (which may be optional), the base station transmits to the UE the user data which was carried in the transmission that the host computer initiated, in accordance with the teachings of the embodiments described throughout this disclosure. In step 1540 (which may also be optional), the UE executes a client application associated with the host application executed by the host computer.

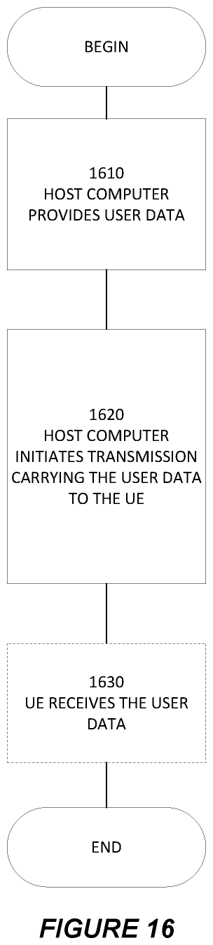

FIG. 16 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 16 will be included in this section. In step 1610 of the method, the host computer provides user data. In an optional substep (not shown) the host computer provides the user data by executing a host application. In step 1620, the host computer initiates a transmission carrying the user data to the UE. The transmission may pass via the base station, in accordance with the teachings of the embodiments described throughout this disclosure. In step 1630 (which may be optional), the UE receives the user data carried in the transmission.

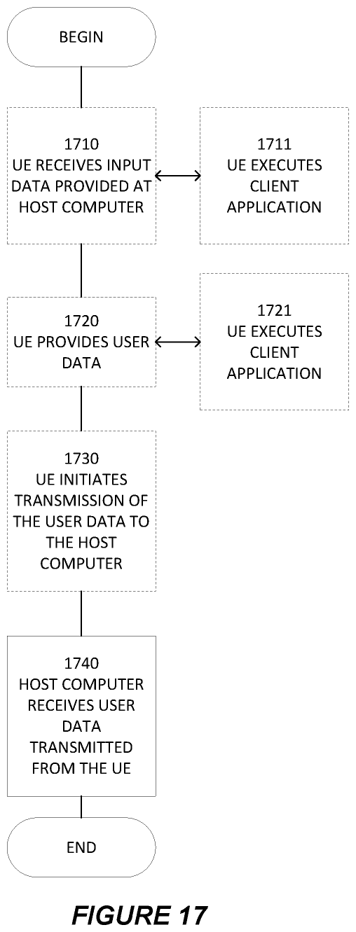

FIG. 17 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 17 will be included in this section. In step 1710 (which may be optional), the UE receives input data provided by the host computer. Additionally or alternatively, in step 1720, the UE provides user data. In substep 1721 (which may be optional) of step 1720, the UE provides the user data by executing a client application. In substep 1711 (which may be optional) of step 1710, the UE executes a client application which provides the user data in reaction to the received input data provided by the host computer. In providing the user data, the executed client application may further consider user input received from the user. Regardless of the specific manner in which the user data was provided, the UE initiates, in substep 1730 (which may be optional), transmission of the user data to the host computer. In step 1740 of the method, the host computer receives the user data transmitted from the UE, in accordance with the teachings of the embodiments described throughout this disclosure.

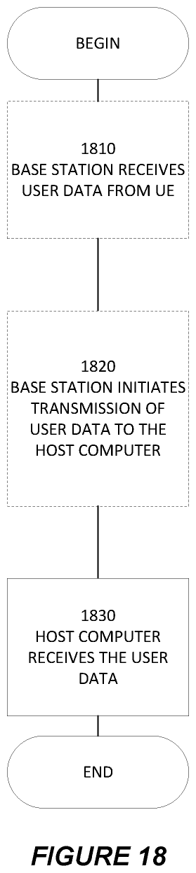

FIG. 18 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 18 will be included in this section. In step 1810 (which may be optional), in accordance with the teachings of the embodiments described throughout this disclosure, the base station receives user data from the UE. In step 1820 (which may be optional), the base station initiates transmission of the received user data to the host computer. In step 1830 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

In view of the above, then, embodiments herein generally include a communication system including a host computer. The host computer may comprise processing circuitry configured to provide user data. The host computer may also comprise a communication interface configured to forward the user data to a cellular network for transmission to a user equipment (UE). The cellular network may comprise a base station having a radio interface and processing circuitry, the base station's processing circuitry configured to perform any of the steps of any of the embodiments described above for a base station.

In some embodiments, the communication system further includes the base station.

In some embodiments, the communication system further includes the UE, wherein the UE is configured to communicate with the base station.

In some embodiments, the processing circuitry of the host computer is configured to execute a host application, thereby providing the user data. In this case, the UE comprises processing circuitry configured to execute a client application associated with the host application.

Embodiments herein also include a method implemented in a communication system including a host computer, a base station and a user equipment (UE). The method comprises, at the host computer, providing user data. The method may also comprise, at the host computer, initiating a transmission carrying the user data to the UE via a cellular network comprising the base station. The base station performs any of the steps of any of the embodiments described above for a base station.

In some embodiments, the method further comprising, at the base station, transmitting the user data.

In some embodiments, the user data is provided at the host computer by executing a host application. In this case, the method further comprises, at the UE, executing a client application associated with the host application.

Embodiments herein also include a user equipment (UE) configured to communicate with a base station. The UE comprises a radio interface and processing circuitry configured to perform any of the embodiments above described for a UE.

Embodiments herein further include a communication system including a host computer. The host computer comprises processing circuitry configured to provide user data, and a communication interface configured to forward user data to a cellular network for transmission to a user equipment (UE). The UE comprises a radio interface and processing circuitry. The UE's components are configured to perform any of the steps of any of the embodiments described above for a UE.

In some embodiments, the cellular network further includes a base station configured to communicate with the UE.

In some embodiments, the processing circuitry of the host computer is configured to execute a host application, thereby providing the user data. The UE's processing circuitry is configured to execute a client application associated with the host application.

Embodiments also include a method implemented in a communication system including a host computer, a base station and a user equipment (UE). The method comprises, at the host computer, providing user data and initiating a transmission carrying the user data to the UE via a cellular network comprising the base station. The UE performs any of the steps of any of the embodiments described above for a UE.

In some embodiments, the method further comprises, at the UE, receiving the user data from the base station.

Embodiments herein further include a communication system including a host computer. The host computer comprises a communication interface configured to receive user data originating from a transmission from a user equipment (UE) to a base station. The UE comprises a radio interface and processing circuitry. The UE's processing circuitry is configured to perform any of the steps of any of the embodiments described above for a UE.

In some embodiments the communication system further includes the UE.

In some embodiments, the communication system further including the base station. In this case, the base station comprises a radio interface configured to communicate with the UE and a communication interface configured to forward to the host computer the user data carried by a transmission from the UE to the base station.

In some embodiments, the processing circuitry of the host computer is configured to execute a host application. And the UE's processing circuitry is configured to execute a client application associated with the host application, thereby providing the user data.

In some embodiments, the processing circuitry of the host computer is configured to execute a host application, thereby providing request data. And the UE's processing circuitry is configured to execute a client application associated with the host application, thereby providing the user data in response to the request data.

Embodiments herein also include a method implemented in a communication system including a host computer, a base station and a user equipment (UE). The method comprises, at the host computer, receiving user data transmitted to the base station from the UE. The UE performs any of the steps of any of the embodiments described above for the UE.

In some embodiments, the method further comprises, at the UE, providing the user data to the base station.

In some embodiments, the method also comprises, at the UE, executing a client application, thereby providing the user data to be transmitted. The method may further comprise, at the host computer, executing a host application associated with the client application.

In some embodiments, the method further comprises, at the UE, executing a client application, and, at the UE, receiving input data to the client application. The input data is provided at the host computer by executing a host application associated with the client application. The user data to be transmitted is provided by the client application in response to the input data.

Embodiments also include a communication system including a host computer. The host computer comprises a communication interface configured to receive user data originating from a transmission from a user equipment (UE) to a base station. The base station comprises a radio interface and processing circuitry. The base station's processing circuitry is configured to perform any of the steps of any of the embodiments described above for a base station.

In some embodiments, the communication system further includes the base station.

In some embodiments, the communication system further includes the UE. The UE is configured to communicate with the base station.

In some embodiments, the processing circuitry of the host computer is configured to execute a host application. And the UE is configured to execute a client application associated with the host application, thereby providing the user data to be received by the host computer.

Embodiments moreover include a method implemented in a communication system including a host computer, a base station and a user equipment (UE). The method comprises, at the host computer, receiving, from the base station, user data originating from a transmission which the base station has received from the UE. The UE performs any of the steps of any of the embodiments described above for a UE.

In some embodiments, the method further comprises, at the base station, receiving the user data from the UE.

In some embodiments, the method further comprises, at the base station, initiating a transmission of the received user data to the host computer.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Some of the embodiments contemplated herein are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

1.-32. (canceled)

33. A wireless device comprising:
communication circuitry; and
processing circuitry configured to:
detect a failure by the wireless device to perform a conditional mobility procedure; and
transmit to a network node a message that indicates, and/or includes information about, the failure by the wireless device to perform the conditional mobility procedure.

34. The wireless device of claim 33, wherein the message reports a connection failure experienced by the wireless device, wherein the message includes a failure type field that indicates the connection failure was due to the failure by the wireless device to perform the conditional mobility procedure.

35. The wireless device of claim 33, wherein the message includes information about a cause of the failure by the wireless device to perform the conditional mobility procedure.

36. The wireless device of claim 33, wherein the failure is caused by an inability of the wireless device to comply with a configuration for a target cell of the conditional mobility procedure.

37. The wireless device of claim 36, wherein the message indicates which configuration the wireless device was unable to comply with and/or which target cell was associated with the configuration.

38. The wireless device of claim 33, wherein the failure is caused by:
failure of the wireless device to connect to a target cell of the conditional mobility procedure after fulfillment of one or more conditions for performing the conditional mobility procedure;
expiration of a first timer before the conditional mobility procedure has successfully completed, wherein the first timer is started when the wireless device detects fulfillment of one or more conditions for performing the conditional mobility procedure;
radio link failure while the wireless device was monitoring for fulfillment of one of more conditions for performing the conditional mobility procedure;
expiration of a second timer, wherein the second timer is configured to start when a downlink quality falls below a threshold;
a random access problem; or
a maximum number of retransmissions being reached.

39. The wireless device of claim 33, wherein the processing circuitry is further configured to receive a conditional mobility configuration for the conditional mobility procedure and to check whether the wireless device is able to comply with the conditional mobility configuration, wherein the message is transmitted based on the wireless device being unable to comply with the conditional mobility configuration according to said checking.

40. The wireless device of claim 39, wherein either:
the conditional mobility configuration includes a configuration for a target cell of the conditional mobility procedure, wherein the processing circuitry is configured to check whether the wireless device is able to comply with the configuration for the target cell, and wherein the message is transmitted based on the wireless device being unable to comply with the configuration for the target cell according to said checking; or
the conditional mobility configuration includes a monitoring configuration, wherein the monitoring configuration is a configuration that the wireless device is to apply in order to monitor for fulfillment of a condition under which the wireless device is to perform the conditional mobility procedure, wherein the processing circuitry is configured to check whether the wireless device is able to comply with the monitoring configuration, and wherein the message is transmitted based on the wireless device being unable to comply with the monitoring configuration according to said checking.

41. The wireless device of claim 33, wherein the processing circuitry is further configured to, responsive to detecting the failure, store the information about the failure at the wireless device, wherein the information included in the message transmitted to the network node includes the stored information.

42. The wireless device of claim 41, wherein the processing circuitry is further configured to:
responsive to detecting the failure, perform cell selection to select a suitable cell and, if the suitable cell selected is a cell for which the wireless device has a stored conditional mobility configuration, apply the stored conditional mobility configuration; and
transmit a message to the suitable cell selected indicating that a failure report is available at the wireless device.

43. A network node comprising:
communication circuitry; and
processing circuitry configured to receive, from a wireless device, a message that indicates, and/or includes information about, a failure by the wireless device to perform a conditional mobility procedure.

44. The network node of claim 43, wherein the message reports a connection failure experienced by the wireless device, wherein the message includes a failure type field that indicates the connection failure was due to the failure by the wireless device to perform the conditional mobility procedure.

45. The network node of claim 43, wherein the message includes information about a cause of the failure by the wireless device to perform the conditional mobility procedure.

46. The network node of claim 43, wherein the failure is caused by an inability of the wireless device to comply with a configuration for a target cell of the conditional mobility procedure.

47. The network node of claim 46, wherein the message indicates which configuration the wireless device was unable to comply with and/or which target cell was associated with the configuration.

48. The network node of claim 43, wherein the failure is caused by:
failure of the wireless device to connect to a target cell of the conditional mobility procedure after fulfillment of one or more conditions for performing the conditional mobility procedure;
expiration of a first timer at the wireless device before the conditional mobility procedure has successfully completed, wherein the first timer is started when the wireless device detects fulfillment of one or more conditions for performing the conditional mobility procedure;
radio link failure while the wireless device was monitoring for fulfillment of one of more conditions for performing the conditional mobility procedure;
expiration of a second timer at the wireless device, wherein the second timer is configured to start when a downlink quality falls below a threshold;
a random access problem; or
a maximum number of retransmissions being reached at the wireless device.

49. The network node of claim 43, wherein the processing circuitry is further configured to transmit, to the wireless device, a conditional mobility configuration for the conditional mobility procedure, wherein the message is received based on the wireless device being unable to comply with the conditional mobility configuration.

50. The network node of claim 49, wherein either:
the conditional mobility configuration includes a configuration for a target cell of the conditional mobility procedure, and wherein the message is received based on the wireless device being unable to comply with the configuration for the target cell; or
the conditional mobility configuration includes a monitoring configuration, wherein the monitoring configuration is a configuration that the wireless device is to apply in order to monitor for fulfillment of a condition under which the wireless device is to perform the conditional mobility procedure, and wherein the message is received based on the wireless device being unable to comply with the monitoring configuration.

51. The network node of claim 43, wherein the processing circuitry is further configured to tune one or more parameters at the network node based on the information about the failure by the wireless device to perform the conditional mobility procedure.

52. A method performed by a wireless device, the method comprising:
detecting a failure by the wireless device to perform a conditional mobility procedure; and
transmitting to a network node a message that indicates, and/or includes information about, the failure by the wireless device to perform the conditional mobility procedure.
